(19) United States
(12) Patent Application Publication
(10) Pub. No.: US 2009/0011334 A1
(43) Pub. Date: Jan. 8, 2009

(54) LITHIUM SECONDARY BATTERY AND POSITIVE ELECTRODE MATERIAL THEREOF

(75) Inventors: Kenji Shizuka, Ibaraki (JP); Kenji Okahara, Ibaraki (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI CHEMICAL CORPORATION, Minato-ku (JP)

(21) Appl. No.: 11/815,319

(22) PCT Filed: Feb. 2, 2006
(86) PCT No.: PCT/JP2006/301734

§ 371 Date: Aug. 2, 2007

(30) Foreign Application Priority Data
Feb. 8, 2005 (JP) 2005-031972

(51) Int. Cl. H01M 4/52; H01M 4/50; H01M 4/26; C01D 15/02

(52) U.S. Cl. 429/223; 429/224; 429/231.95; 423/594.4

(57) ABSTRACT

A lithium nickel manganese cobalt complex oxide powder for a lithium secondary battery positive electrode material, which is composed of a crystal structure having a layered structure, and the composition thereof is expressed by the following formula:

Li[Li_{z/(2+z)}{(LiₓNi_{(1-3x)/2}Mn_{(1+x)/2})_{(1-y)}Co_{y}}_{2/(2+z)}]O₂
wherein 0.01≦x≦0.15, 0≦y≦0.35, and 0.02(1−y)(1−3x)≦z≦0.15(1−y)(1−3x).

### TECHNICAL FIELD

The present invention relates to a lithium nickel manganese cobalt complex oxide powder used as a lithium secondary battery positive electrode material, a method for preparing the same, a lithium secondary battery positive electrode including the complex oxide powder, and a lithium secondary battery provided with the positive electrode.

### BACKGROUND ART

Lithium secondary cells are excellent in terms of energy density, output density, and other properties, and are used as power sources for portable devices such as notebook PCs, mobile telephones and handy video cameras. Lithium secondary cells also attract attention as power sources for electric automobiles and for load leveling of electric power.

As positive electrode active materials for lithium secondary batteries, lithium manganese complex oxides having a spinel structure, layered lithium nickel complex oxides, and layered lithium cobalt complex oxides are used. Lithium manganese complex oxides having a spinel structure are inexpensive, can be synthesized without great difficulty, and are excellent in terms of safety when made into a battery, although they have a low capacity and poor high-temperature properties (cycle and storage). Layered lithium nickel complex oxides have a high capacity and excellent high-temperature properties, although they are difficult to synthesize and inferior in terms of stability when made into a battery. Layered lithium cobalt complex oxides are also expensive.

Lithium nickel manganese cobalt complex oxides having a composition range in which the manganese/nickel atomic ratio is greater than 1 are disclosed in the following Patent Documents 1, 2, and Non-Patent Documents 1 to 8.

Regarding the complex oxides described in Patent Document 1 and Non-Patent Documents 1 to 8, the below-described excess z of Li defined in the present invention is limited to 0. According to Patent Document 2, the manganese/nickel atomic ratio is too large to sufficiently enhance the battery performance.

Patent Document 3 discloses a positive electrode material having a composition having a manganese/nickel atomic ratio equivalent to 1. The battery provided with the positive electrode exhibits poor charge/discharge cycle characteristics when the charge voltage thereof is set to high values. Patent Document 3 does not disclose any measures taken for maintaining the cycle characteristics when the manganese/nickel atomic ratio is greater than 1 and the charge voltage is set to an even higher value. In addition, there is no description about the concentration C of carbon contained therein, which affects the battery performance by serving as an impurity constituent causing side reaction or existing on the surface or at grain boundaries of a positive electrode active material to inhibit the intercalation/deintercalation of lithium ions. Further, the influence of the volume resistivity on the battery performance is not described therein at all.

Patent Document 1: Japanese Patent Application Laid-Open (JP-A) No. 2004-6267

Patent Document 2: U.S. Pat. No. 6,680,143B2

### Patent Document 3: Japanese Patent No. 3571671

Non-Patent Document 1: Electrochem. Solid-State Lett., 4 (2001) A194
Non-Patent Document 2: J. Power sources, 119-121 (2003) 166
Non-Patent Document 3: J. Power sources, 129 (2004) 288
Non-Patent Document 4: Electrochem. Solid-State Lett., 7 (2004) A167
Non-Patent Document 5: J. Power sources, 119-121 (2003) 161

### Non-Patent Document 6: Solid State Ionics, 164 (2003) 43

### Non-Patent Document 7: J. Electrochem, Soc., 149 (2002) A815

Non-Patent Document 8: Electrochem. Com. 6 (2004) 1085

### DISCLOSURE OF INVENTION

The present invention is intended to provide a lithium nickel manganese cobalt complex oxide powder for a lithium secondary battery positive electrode material which allows the reduction of the cost, increase of the resistance to high voltages, promotion of safety, and improvement of the battery performance of a lithium secondary battery. In addition, the present invention is also intended to provide a positive electrode including the complex oxide and a lithium secondary battery provided with the positive electrode.

The lithium nickel manganese cobalt complex oxide powder of the present invention for a lithium secondary battery positive electrode material is composed of a lithium nickel manganese cobalt complex oxide having a composition expressed by the following formula (I), wherein the complex oxide contains a crystal structure having a layered structure:

Li[Li_{z/(2+z)}{(LiₓNi_{(1-3x)/2}Mn_{(1+x)/2})_{(1-y})Co_{y}}_{2/(2+z)}]O₂ (I)

0.01≦x≦0.15

0≦y≦0.35

0.02(1−y)(1−3x)≦z≦0.15(1−y)(1−3x)

The method for making the complex oxide powder of the present invention includes pulverizing a nickel compound, a manganese compound, and a cobalt compound, uniformly dispersing them to make a slurry, spray drying and/or pyrolyzing the slurry to agglomerate the primary particles into secondary particles to make powder, thereafter mixing the powder with a lithium compound, and firing the resultant mixture in an oxygen-containing gas atmosphere.

The lithium secondary battery positive electrode of the present invention has a collector, and a positive electrode active material layer formed on the collector, wherein the positive electrode active material layer contains the above-described complex oxide powder of the present invention and a binding agent.

The lithium secondary battery of the present invention is a lithium secondary battery provided with a negative electrode capable of intercalating/deintercalating lithium, a nonaqueous electrolyte containing a lithium salt, and a positive electrode capable of intercalating/deintercalating lithium, wherein the lithium secondary battery positive electrode of the present invention is used as the positive electrode.

### BRIEF DESCRIPTION OF THE DRAWINGS

FIG. 1 is a graph showing an XRD pattern of the complex oxide prepared in Example 1.

FIG. 2 is a graph showing an XRD pattern of the complex oxide prepared in Example 2.

FIG. 3 is a graph showing an XRD pattern of the complex oxide prepared in Example 3.

FIG. 4 is a graph showing an XRD pattern of the complex oxide prepared in Example 4.

FIG. 5 is a graph showing an XRD pattern of the complex oxide prepared in Comparative Example 1.

FIG. 6 is a graph showing an XRD pattern of the complex oxide prepared in Comparative Example 2.

FIG. 7 is a graph showing an XRD pattern of the complex oxide prepared in Comparative Example 3.

FIG. 8 is a graph showing an XRD pattern of the complex oxide prepared in Comparative Example 4.

FIG. 9 is a graph showing an XRD pattern of the complex oxide prepared in Comparative Example 5.

### BEST MODE FOR CARRYING OUT THE INVENTION

A lithium secondary battery having a positive electrode including the lithium nickel manganese cobalt complex oxide of the present invention is low-cost, resistant to high voltages, and highly safe, in addition, has improved rate and output characteristics.

The lithium nickel manganese cobalt complex oxide having the above-described crystal structure having a layered structure may be that expressed by LiMeO₂ (Me is a transition metal), which has a structure equivalent to that of a lithium transition metal oxide composed of a lithium layer, a transition metal layer, and an oxygen layer stacked in a uniaxial direction. Typical examples of LiMeO₂ include those having α—NaFeO₂ type such as LiCoO₂ and LiNiO₂, which are hexagonal and has the space group:

R 3̅m [formula 2]

(hereinafter represented as “layered R(-3)ₘ structure”) based on the symmetry thereof.

However, the layered LiMeO₂ is not limited to the layered R(-3)m structure. The layered LiMeO₂ may be LiMnO₂ referred to as layered Mn, which is an orthorhombic layered compound having the space group Pm2m. The layered complex oxide may be LiMnO₂ referred to as the 213 phase. It may be also represented as Li[Li_{1/3}Mn_{2/3}]O₂, has a monoclinic space group C2/m structure, and is also a layered compound in which a Li layer, a [Li_{1/3}Mn_{2/3}] layer, and an oxygen layer are stacked.

According to the composition of the present invention, the z value is expressed by 0.02(1−y)(1−3x)≦z≦0.15(1−y)(1−3x), so that the Li amount is in a range slightly higher than the stoichiometric composition, which improves the battery performance (particularly rate characteristics and output characteristics). The reason is considered as follows.

When the layered structure is a layered R(-3)m structure, the valence of Ni changes from two to three (Ni(II)→Ni(III)) as the substitution of the transition metal site (3b) of excess Li, which increases the ratio of Ni(III) to Ni(II), and increases the average valence of Ni. As a result, the electronic state of the crystal varies to improve the powder conductivity, or decrease the resistivity. In addition, the amount of Li site (3a) substituted with Ni(II) (occupancy) decreases, which suppresses the disorder in the crystal structure and smoothen the diffusion of Li ions.

The inventors measured the XANES (X-ray absorption near-edge structure) spectrum of the samples containing systematically varied amounts of excess lithium, and found that the valence of Mn and Co was constant and did not change from Mn(IV) and Co(III), respectively, but the valence of Ni changed from two to three as expressed by Ni (II)→Ni (III).

When the lithium secondary battery having a positive electrode including a complex oxide having an x value satisfying 0.01≦x≦0.15 and a Mn/Ni atomic ratio of 1 or more is charged to a high charge potential, it exhibits improved cycle characteristics and safety. The reason for this is considered that the crystal structure is more stabilized by the increase in the Mn/Ni atomic ratio, in addition, the amount of Li site substituted with Ni(II) (occupancy) is decreased in relation to the decrease in the proportion of the Ni amount, hence the disorder in the crystal structure is suppressed.

The chemical implications of z and x in the formula (I) are described below in more detail.

The lithium nickel manganese cobalt complex oxide of the present invention is composed of a crystal structure having a layered structure.

As aforementioned, the layered structure is not necessarily limited to the R(-3)m structure, but preferably has the R(-3)m structure from the viewpoint of electrochemical performance. The complex oxide having a layered structure of the R(-3)m structure is described below in detail.

A layered lithium transition metal complex oxide containing Li[Ni_{1/2}Mn_{1/2}]O₂ in the proportion of (1−3x)(1−y), Li[Li_{1/3}Mn_{2/3}]O₂ in the proportion of 3x(1−y), and LiCoO₂ in the proportion of y, wherein these components have been solid-dissolved, is expressed by the following formula:

[Li]^{(3a)}[(LiₓNi_{(1-3x)/2}Mn_{(1+x)/2})_{(1-y)}Co_{y}]^{(3b)}O₂ (II)

wherein (3a) and (3b) each represent different metal sites in the layered R(-3) m structure.

The complex oxide of the present invention is expressed by the following formula (I), wherein an excess of z moles of Li has been solid-dissolved in the composition of the formula (II):

[Li]^{(3a)}[(Li_{z/(2+z)}{[LiₓNi_{(1-3x)/2}Mn_{(1+x)/2}]_{(1-y)}Co_{y}}_{2/(2-z)]}^{(3b)}O₂ (I)

wherein 0.01≦x≦0.15, 0≦y≦0.35, and 0.02(1−y)(1−3×)≦z≦0.15(1−y)(1−3x).

The x, y, and z values in the formula (I) are determined by analyzing the transition metals and Li with an inductively coupled plasma spectrophotometer (ICP-AES), and calculating the Li/Ni/Mn/Co ratio. More specifically, the x and y values are determined from the Ni/Mn and Co/Ni ratios, and the z value is determined by the fact that the Li/Ni molar ratio is expressed by:

Li/Ni={2+2z+2x(1−y)}/{(1−3x)(1−y)}.

Both of the Li defined by z and the Li defined by x is considered to be placed in the same transition metal site by substitution. The difference between the Li defined by x and the Li defined by z depends on whether the valence of Ni is higher or not higher than two, or whether trivalent Ni generates or not. More specifically, since x is a value linked to the Mn/Ni ratio (Mn abundance), the Ni valence will not vary depending exclusively on the x value, and Ni remains divalent. On the other hand, z is interpreted as Li increasing the valence of Ni, wherein the z value is an index of the Ni valence (proportion of Ni(III)).

On the assumption that the Co valence is three and the Mn valence is four, the Ni valence (m) incident to the change of z is calculated according to the formula (I) as follows: m=2z/{(1−y)(1−3x)}+2. The calculation result indicates that the Ni valence is not exclusively dependent on z, but is a function of x and y. When z=0, the Ni valence remains two regardless of the x and y values. In other words, even if the z value is same, the Ni valence is higher in a composition richer in Mn (having a higher x value) and/or richer Co (having a higher y value). When the composition is included in a battery, the rate characteristics and the output characteristics improve, but the capacity tends to decrease. Accordingly, the upper limit of the z value is more preferably defined as a function of x and y as described above.

When the y value is 0≦y≦0.35 and the Co amount is in a smaller range, the cost declines, in addition, a lithium secondary battery having a positive electrode including the complex oxide exhibits improved high cycle characteristics and safety when charged to a high charge potential.

The lithium nickel manganese cobalt complex oxide powder of the present invention for a lithium secondary battery positive electrode material allows, when used as a lithium secondary battery positive electrode material, to strike a balance between the improvement of the battery performance and the cost reduction, increase of the resistance to high voltages, and promotion of safety. Therefore, according to the present invention, there is provided an excellent lithium secondary battery which is low-cost, highly safe, and able to maintain high performance even when used at a high charge voltage.

Preferable embodiments of the present invention are described below in more detail.

[Lithium Nickel Manganese Cobalt Complex Oxide]

<Composition>

The lithium nickel manganese cobalt complex oxide of the present invention for a lithium secondary battery positive electrode material is composed of a crystal structure having a layered structure, the composition being expressed by the following formula (I):

Li[Li_{z/(2+z)}{(LiₓNi_{(1-3x)/2}Mn_{(1+x)/2})_{(1-y})Co_{y}}_{2/(2+z)]O}₂ (I)

0.01≦x≦0.15

0≦y≦0.35

0.02(1−y)(1−3x)≦z≦0.15(1−y)(1−3x)

In the formula (I), the z value is 0.02(1−y)(1−3×) or more, preferably 0.03(1−y)(1−3x) or more, more preferably 0.04(1−y)(1−3x) or more, further preferably 0.05(1−y)(1−3x) or more, and most preferably 0.06(1−y)(1−3x) or more, in addition, 0.15(1−y)(1−3x) or less, preferably 0.14(1−y)(1−3x) or less, more preferably 0.13(1−y)(1−3x) or less, and most preferably 0.12(1−y)(1−3x) or less. If below the lower limit, the electrical conductivity may decrease, and if above the upper limit, the transition metal site is excessively substituted, which may result in the performance deterioration of the lithium secondary battery including the same, such as the decrease of the battery capacity.

In addition, if z is too large, the active material powder has higher carbon dioxide absorptivity, so that it readily absorbs carbon dioxide in the air. As a result, the carbon concentration presumably increases.

On the other hand, if z is too small, the amount of Li for forming the phase composed mainly of a layered structure is apparently insufficient, hence a spinel phase emerges as a heterogenous phase.

The x value is 0.01 or more, preferably 0.03 or more, more preferably 0.04 or more, most preferably 0.05 or more, in addition, 0.15 or less, preferably 0.14 or less, more preferably 0.13 or less, and most preferably 0.12 or less. If below the lower limit, the storage stability decreases to readily cause deterioration, which may result in the decrease in the stability at high voltages and the deterioration of safety. If above the upper limit, a heterogenous phase tends to generate, and the deterioration of the battery performance tends to occur.

The y value is 0 or more, preferably 0.05 or more, more preferably 0.10 or more, most preferably 0.15 or more, in addition, 0.35 or less, preferably 0, 30 or less, more preferably 0.25 or less, and most preferably 0.20 or less.

In the composition range of the formula (I), as the z value approaches the lower limit or the stoichiometric ratio, the rate characteristics and the output characteristics of the resultant battery tend to deteriorate. As the z value approaches the upper limit, the rate characteristics and the output characteristics of the resultant battery tend to increase, while the capacity thereof tends to decrease.

As the x value approaches the lower limit, or the manganese/nickel atomic ratio approaches 1, a certain capacity is obtained at a lower charge voltage, but the cycle characteristics and safety of the battery set to a high charge voltage tends to decrease.

As the x value approaches the upper limit, the battery set to a high charge voltage exhibits improved cycle characteristics and safety, while the discharge capacity, rate characteristics, and output characteristics thereof tend to deteriorate.

As the y value approaches the lower limit, the load characteristics of the resultant battery such as the rate characteristics and the output characteristics tend to deteriorate.

As the y value approaches the upper limit, the rate characteristics and the output characteristics of the resultant battery improve, but when it is set to a high charge voltage, the cycle characteristics and safety tend to deteriorate, and the raw material cost tends to increase.

In the composition of the formula (I), the atomic ratio of the oxygen amount is expediently described as 2, but may be partially nonstoichiometric. For example, the atomic ratio of oxygen may be in the range of 2±0.1.

The lithium nickel manganese cobalt complex oxide powder of the present invention may have a substituent element in the structure thereof. The substituent element is at least one selected from Al, Fe, Ti, Mg, Cr, Ga, Cu, Zn, Nb, Zr, Mo, W, and Sn. These substituent elements appropriately substitute Ni, Mn, Co elements in the proportion of 20 at % or lower.

<Powder X Ray Diffraction Peak>

The complex oxide powder of the present invention preferably has no diffraction peak at 2θ=31±1° in a X-ray powder diffraction peak using CuKα radiation. The description “no diffraction peak” includes diffraction peaks which does not adversely affect the battery performance of the present invention. More specifically, the diffraction peak is derived from a spinel phase, and the inclusion of a spinel phase deteriorates the capacity, rate characteristics, high temperature storage characteristics, and high temperature cycle characteristics of the resultant battery. Therefore, the diffraction peak may have a diffraction peak which does not adversely affect the battery performance of the present invention. With reference to the (003) peak area at 2θ=18.5±1°, the diffraction peak area at 2θ=31±1° is preferably in a proportion of 0.5% or less, more preferably in a proportion of 0.2% or less, and particularly preferably absent. The diffraction peak is derived from a spinel phase. If a spinel phase is included, the capacity, rate characteristics, high temperature storage characteristics, and high temperature cycle characteristics of the resultant battery may deteriorate. Therefore, the diffraction peak is preferably absent.

<Crystal Structure>

The complex oxide powder of the present invention is composed of a crystal structure containing a layered R(-3)m structure, wherein the lattice constants are preferably in the range of 2.855 Å≦a≦2.870 Å and 14.235 Å≦c≦14.265 Å. In the present invention, the crystal structure and the lattice constants may be determined by X-ray powder diffractometry using CuKα radiation.

<Carbon Concentration C>

The C content in the complex oxide powder of the present invention is usually 0.030% by weight or less, preferably 0.025% by weight or less, and further preferably 0.020% by weight or less, in addition, usually 0.001% by weight or more, preferably 0.004% by weight or more, and further preferably 0.010% by weight or more. If the C value is greater than the upper limit, swelling of the resultant battery may increase because of gas generation, or the battery performance may deteriorate, and if below the lower limit, the battery performance may deteriorate.

The carbon concentration C in the complex oxide powder may be determined, as described in the following EXAMPLES, by measuring the infrared ray absorption of the sample fired in an oxygen flow (by high frequency heating).

According to the carbon concentration determined by the below-described carbon analysis of the complex oxide powder, there is general agreement between the value based on the assumption that all portions of the carbon are derived from carbonate ions and the carbonate ion concentration in the complex oxide powder analyzed by ion chromatography, which suggests that most portions of carbon exist as carbonate. Accordingly, the C value can be regarded as a value indicating information regarding the deposit of carbonate compounds, particularly lithium carbonate.

The quantity of lithium existing as a carbonate in the lithium nickel manganese cobalt complex oxide of the present invention powder is so small that it will not influence the lithium composition (x, z) defined by the complex oxide powder.

<Volume Resistivity>

The value of the volume resistivity of the complex oxide powder of the present invention when consolidated under a pressure of 40 MPa is usually 5×10⁵ Ω·cm or less, preferably 2×10⁵ Ω·cm or less, more preferably 1×10⁵ Ω·cm or less, and particularly preferably 5×10⁴ Ω·cm or less. If the volume resistivity is greater than the upper limit, the rate characteristics or the low-temperature characteristics of the resistant battery may deteriorate. The lower limit of the volume resistivity is usually 5×10¹ Ω·cm or more, preferably 1×10² Ω·cm or more, further preferably 5×10² Ω·cm or more, and most preferably 1×10³ Ω·cm or more. If the volume resistivity is below the lower limit, safety of the resistant battery may deteriorate.

The volume resistivity of the complex oxide powder is a volume resistivity of the complex oxide powder in the state of being compacted at a pressure of 40 MPa, as measured under the conditions of a four-probe ring electrode, an electrode spacing of 5.0 mm, an electrode radius of 1.0 mm, a sample radius of 12.5 mm, and an applied-voltage limiter of 90 V. The volume resistivity of a powder under the given pressure can be measured, for example, with a powder resistivity measuring apparatus (for example, powder resistivity measuring system LORESTA GP, manufactured by DIA Instruments Co., Ltd.) using a probe unit for powders.

<Bulk Density>

The bulk density of the complex oxide powder of the present invention is usually 1.5 g/cc or more, preferably 1.7 g/cc or more, more preferably 1.9 g/cc or more, and most preferably 2.0 g/cc or more. If below the lower limit, the packing property of the powder and the electrode preparation are adversely affected, and the positive electrode using the powder as an active material will have a low volume density per unit capacity. In addition, the upper limit of the bulk density is usually 3 g/cc or less, preferably 2.8 g/cc or less, and more preferably 2.6 g/cc or less. A bulk density greater than the upper limit is desirable for the improvement in the packing property of the powder and the electrode density, while excessively decreases the specific surface area and deteriorate the battery performance.

The bulk density of the powder may be determined by placing 5 to 10 g of the complex oxide powder in a 10-ml glass graduated cylinder, and measuring the powder packing density (tap density) g/cc after 200 times of tapping with a stroke of about 20 mm.

<Average Primary Particle Diameter>

The average primary particle diameter of the complex oxide powder of the present invention is usually 0.1 μm or more, preferably 0.2 μm or more, further preferably 0.3 μm or more, and most preferably 0.4 μm or more, in addition, usually 3 μm or less, preferably 2 μm or less, further preferably 1.5 μm or less, and most preferably 1.0 μm or less. If greater than the upper limit, spherical secondary particles are less likely to form, which may adversely affect the packing property of the powder and significantly decrease the specific surface area thereby deteriorating the battery performance such as the rate characteristics and output characteristics. If below the lower limit, undeveloped crystals may cause problems such as the deterioration of the charge/discharge reversibility.

The average particle diameter of the primary particles is an average diameter observed with a scanning electron microscope (SEM), and may be determined as an average particle diameter of about 10 to 30 primary particles in a 30,000 magnified SEM image.

<Median Diameter and 90% Integrated Diameter (D₉₀) of Secondary Particles)

The complex oxide powder of the present invention preferably contains secondary particles composed of sintered primary particles.

The median diameter of the secondary particles is usually 3 μm or more, preferably 5 μm or more, more preferably 9 μm or more, and most preferably 10 μm or more, in addition, usually 20 μm or less, preferably 18 μm or less, more preferably 16 μm or less, and most preferably 15 μm or less. If below the lower limit, the resultant product may not have a high bulk density, and if greater than the upper limit, the battery performance may deteriorate, and the application may be difficult in the formation of a positive electrode active material layer.

The 90% integrated diameter (D₉₀) of the secondary particles is usually 30 μm or less, preferably 26 μm or less, more preferably 23 μm or less, and most preferably 20 μm or less, in addition, usually 5 μm or more, preferably 8 μm or more, more preferably 12 μm or more, and most preferably 15 μm or more. If greater than the upper limit, the battery performance may deteriorate, and the application may be difficult in the formation of a positive electrode active material layer. If below the lower limit, the resultant product may not have a high bulk density.

The median diameter as the average particle diameter and 90% integrated diameter (D₉₀) are measured using a known laser diffraction/scattering particle size distribution analyzer at a refractive index of 1.24 and on the basis of the particle volume diameter. The dispersion medium used for the measurement is 0.1% by weight sodium hexametaphosphate aqueous solution. The sample is added to the dispersion medium and ultrasonically dispersed therein for 5 minutes, and then subjected to measurement.

<BET Specific Surface Area>

The BET specific surface area of the complex oxide powder of the present invention is usually 0.2 m²/g or more, preferably 0.3 m²/g or more, further preferably 0.4 m²/g or more, and most preferably 0.5 m²/g or more, in addition, usually 3.0 m²/g or less, preferably 1.5 m²/g or less, further preferably 1.2 m²/g or less, and most preferably 1.0 m²/g. If the BET specific surface area is below the range, the battery performance tends to deteriorate, and if greater than the range, the bulk density may be hard to increase, or the applicability tends to be unacceptable in the formation of a positive electrode active material layer.

The BET specific surface area may be measured by a known BET powder specific surface area analyzer. In the present invention, BET one point measurement was conducted according to a continuous flow method with AMS 8000, a full automatic specific surface area analyzer manufactured by Ohkura Riken Inc., using nitrogen and helium as the adsorption gas and carrier gas, respectively. Specifically, the powder sample was heated and deaerated using a mixed gas at a temperature of 150° C., subsequently cooled to the temperature of liquid nitrogen to adsorb the mixed gas, thereafter warmed to room temperature using water to desorb the adsorbed nitrogen gas, and the amount of the gas was detected with a thermal conductivity detector, from which the specific surface area of the sample was calculated.

[Production Method of Complex Oxide Powder]

The lithium nickel manganese cobalt complex oxide powder of the present invention is not specifically limited as to its formula, and, for example, may be prepared by dispersing a nickel compound, a manganese compound, and a cobalt compound in a liquid medium to make a slurry, spray-drying and/or pyrolyzing the slurry, thereafter mixing it with a lithium compound, and then firing the mixture.

Of the raw materials used for the preparation of the slurry, examples of the nickel compound include Ni(OH)₂, NiO, NiOOH, NiCO₃.2Ni (OH)₂.4H₂O, NiC₂O₄.2H₂O, Ni(NO₃)₂.6H₂O, NiSO₄, NiSO₄.6H₂O, nickel fatty acid salts, and nickel halides. Among them, nickel compounds such as Ni(OH)₂, NiO, NIOOH, NiCO₃.2Ni(OH)₂.4H₂O, and NiC₂O₄.2H₂O are preferable because they will not generate toxic substances such as SOₓ and NOₓ during the firing treatment. From the viewpoints of low cost availability as an industrial material and high reactivity, Ni(OH)₂, NiO, and NiOOH are particularly preferable. These nickel compounds may be used alone, or in combination of two or more of them.

Examples of the manganese compound include manganese oxides such as Mn₂O₃, MnO₂, and Mn₃O₄, manganese salts such as MnCO₃, Mn(NO₃)₂, MnSO₄, manganese acetate, manganese dicarboxylate, manganese citrate, and manganese fatty acid salts, and halides such as oxyhydroxides and manganese chloride. Among these manganese compounds, MnO₂, Mn₂O₃, and Mn₃O₄ are preferable because they will not generate gases such as SOₓ, NOₓ, and CO₂ during firing treatment, and are available at a low cost as an industrial material. These manganese compound may be used alone, or in combination of two or more of them.

Examples of the cobalt compound include Co(OH)₂, CoOOH, CoO, Co₂O₃, Co₃O₄, Co(OCOCH₃)₂.4H₂O, CoCl₂, Co(NO₃)₂.6H₂O, and Co(SO₄)₂.7H₂O. Among them, Co(OH)₂, CoOOH, CoO, Co₂O₃, and Co₃O₄ are preferable because they will not generate toxic substances such as SOₓ and NOₓ during the firing step, and Co(OH)₂ and CoOOH are further preferable from the viewpoints of industrial availability at a low cost and high reactivity. These cobalt compound may be used alone, or in combination of two or more of them.

The method for mixing the raw materials is not particularly limited, and may be a wet process or a dry process. Examples of the method include a method using an apparatus such as a ball mill, a vibration mill, or a bead mill. Wet mixing is preferable because it achieves more uniform mixing, and increases the reactivity of the mixture in the firing step. The dispersion medium used in the wet process may be an organic solvent or water, and is preferably water.

The mixing time varies according to the mixing method, and should be enough for uniformly mixing the raw materials on the particle level. For example, mixing with a ball mill (wet process or dry process) requires usually about 1 hour to 2 days, and a bead mill (wet process or dry process) usually requires about 0.1 hour to 6 hours.

In the step of mixing the raw materials, the raw materials are pulverized in parallel with the mixing. The degree of pulverization is, with reference to the diameter of the pulverized raw material particles, usually 0.5 μm or less, preferably 0.3 μm or less, further preferably 0.25 μm or less, and most preferably 0.20 μm or less in terms of the average particle diameter (median diameter). If the average particle diameter of the pulverized raw material particles is too large, the reactivity in the firing step decreases, and the homogenization of the composition becomes difficult. However, since excessive decreases in the diameter can result in the increase in the pulverization cost, pulverization should be conducted to achieve an average particle diameter of usually 0.01 μm or more, preferably 0.02 μm or more, and further preferably 0.05 μm or more. The device for achieving such a degree of pulverization is not particularly limited, but preferably a wet pulverization process. Specific examples thereof include a DYNO mill. The median diameter of the pulverized particles in the slurry described in the below-described EXAMPLES was measured using a known laser diffraction/scattering particle size distribution analyzer at a refractive index of 1.24 and on the basis of the particle volume diameter. In the present invention, the dispersion medium used for the measurement was 0.1% by weight sodium hexametaphosphate aqueous solution, and the measurement was conducted after ultrasonic dispersion for 5 minutes.

The wet mixing is followed by a known drying and/or pyrolysis step. The drying method is not particularly limited, but spray drying is preferable from the viewpoints of the homogeneity and powder flowability of the generated particulate matter, the powder handling performance, and the efficient formation of spherical secondary particles.

After the raw materials are pulverized by wet pulverization to an average particle diameter of 0.3 μm or less, the primary particles are preferably agglomerated by spray drying and/or pyrolysis to produce powder composed of solid secondary particles. The morphological feature of the powder composed of solid secondary particles formed by aggregation of the primary particles is, although the particle size varies, basically reflected in the lithium nickel manganese cobalt complex oxide powder obtained by further mixing the powder with a Li material and firing. Examples of the method for examining the shape include SEM observation and sectional SEM observation.

The average particle diameter of the powder obtained by spray drying and/or pyrolysis is adjusted to usually 50 μm or less, more preferably 40 μm or less, and most preferably 30 μm or less. However, since it is difficult to achieve a too small particle diameter, the particle diameter is usually 3 μm or more, preferably 5 μm or more, and more preferably 6 μm or more. In cases where the particulate matter is prepared by spray drying, the particle diameter thereof may be controlled by appropriately selecting the spraying system, the rate of pressurized gas supply, the rate of slurry supply, the drying temperature, and others.

If the specific surface area of the particulate matter obtained by spray drying and/or pyrolysis is too small, the reactivity with a lithium compound decreases in the following step in which a complex oxide is prepared by firing reaction with a lithium compound. Accordingly, as described above, the specific surface area is preferably maximized by pulverizing the raw materials or other measures before spray drying and/or pyrolysis. On the other hand, the excessive increase in the high specific surface area is not economical. Accordingly, the powder particles obtained by spray drying and/or pyrolysis has a BET specific surface area of usually 20 m²/g or more, preferably 30 m²/g or more, more preferably 40 m²/g or more, further preferably 50 m²/g or more, and most preferably 60 m²/g or more, in addition, usually 200 m²/g or less, and preferably 150 m²/g or less.

Examples of the lithium compound to be mixed with the granulated particles obtained by spray drying and/or pyrolysis include Li₂CO₃, LiNO₃, LiNO₂, LiOH, LiOH.H₂O, LiH, LiF, LiCl, LiBr, LiI, CH₃OOLi, Li₂O, Li₂SO₄, lithium dicarboxylate, lithium citrate, lithium fatty acid salts, and lithium alkyl. In order to avoid generation of toxic substances such as SOₓ and NOₓ during the firing treatment, lithium compounds containing no nitrogen atom or sulfur atom are preferable. In order to minimize the carbon concentration C after the firing treatment, a compound containing no carbon atom is preferable. Accordingly, LiOH and LiOH.H₂O are particularly preferable as the lithium compound. These lithium compounds may be used alone, or in combination of two or more of them.

In order to increase the miscibility with the mixture containing a nickel material, a manganese material, and a cobalt material, and improve the battery performance, the average particle diameter of the lithium compound is usually 500 μm or less, preferably 100 μm or less, more preferably 50 μm or less, further preferably 20 μm or less, and most preferably 10 μm or less. On the other hand, since a lithium compound having a too small particle diameter is poorly stable in the air, the average particle diameter of the lithium compound is usually 0.01 μm or more, preferably 0.1 μm or more, further preferably 0.2 μm or more, and most preferably 0.5 μm or more. The median diameter as the average particle diameter of lithium hydroxide, which was used as a raw material in the below-described EXAMPLES, was measured using a known laser diffraction/scattering particle size distribution analyzer at a refractive index of 1.14 and on the basis of the particle volume diameter. In the measurement, ethyl alcohol was used as the dispersion medium for the measurement, with which a saturated solution of lithium hydroxide was made, and measured after ultrasonic dispersion for 5 minutes.

It is important to thoroughly mix the powder obtained by spray drying and/or pyrolysis and the lithium compound. The mixing technique is not particularly limited as long as it achieves sufficient mixing, but preferably employs a powder mixing apparatus which is generally used for industrial use. The atmosphere in the mixing system is preferably an inert gas such as nitrogen gas or argon gas atmosphere in order to prevent carbon absorption in the air.

The resultant mixed powder is subsequently subjected to firing treatment. The firing conditions vary depending on the composition and the lithium compound material used. As a general trend, if the firing temperature is too high, the particles excessively grow, and if too low, the bulk density is low and the specific surface area is too large. The firing temperature is usually 800° C. or more, preferably 900° C. or more, further preferably 950° C. or more, in addition, usually 1100° C. or less, preferably 1075° C. or less, and further preferably 1050° C. or less.

For the firing, for example, a box furnace, a tubular furnace, a tunnel furnace, a rotary kiln may be used. The firing step is usually divided into warming, maximum temperature keeping, and cooling stages. The second maximum temperature keeping stage is not necessarily conducted at once, and may contain two or more stages according to the intended use. The warming, maximum temperature keeping, and cooling steps may be repeated twice or more times with the intervention of a cracking step for resolving aggregation without breaking the secondary particles, or a pulverizing step for pulverizing to primary particles or minute powder.

In the warming step, the inside of the furnace is warmed at a warming speed of usually from 1° C./minute to 10° C./minute. If the warming speed is too slow, it is unfavorable because much time is required, but if too fast, the temperature in the furnace cannot follow the preset temperature in some furnaces. The warming speed is preferably 2° C./minute or more, and more preferably 3° C./minute or more, in addition, preferably 10° C./minute or less, and more preferably 5° C./minute or less.

The keeping time in the maximum temperature keeping step varies according to the temperature, but in the above-described temperature range, is usually 30 minutes or more, preferably 5 hours or more, and further preferably 10 hours or more, in addition, 50 hours or less, preferably 25 hours or less, and further preferably 20 hours or less. If the firing time is too short, it becomes difficult to obtain a lithium nickel manganese cobalt complex oxide powder with good crystallinity, and excessively long firing time is not practical. Excessively long firing time is unfavorable because cracking may be required or complicated after firing.

In the cooling step, the inside of the furnace is cooled at a cooling speed of usually from 0.1° C./minute to 10° C./minute. If the cooling temperature is too slow, it is industrially unfavorable because much time is required, and if too fast, the objective product may lack homogeneity, or the deterioration of the container tends to be accelerated. The cooling rate is preferably 1° C./minute or more, and more preferably 3° C./minute or more, in addition, preferably 10° C./minute or less, and more preferably 5° C./minute or less.

The atmosphere during firing may be an oxygen-containing gas atmosphere such as air. The atmosphere has an oxygen concentration of usually 1% by volume or more, preferably 10% by volume or more, and more preferably 15% by volume or more, in addition, 100% by volume or less, preferably 50% by volume or less, and more preferably 25% by volume or less.

The Li/Ni/Mn/M molar ratio of the complex oxide may be controlled by adjusting the mixing ratio between a nickel compound, a manganese compound, and a cobalt compound to be dispersed in a liquid medium to prepare a slurry, and adjusting the mixing proportion of a lithium compound to be mixed with the granulated particles obtained by spray drying and/or pyrolysis of the slurry.

With the complex oxide powder, there is provided a lithium secondary battery positive electrode material which undergoes less swelling by gas generation, has a high capacity, exhibits excellent rate characteristics, low temperature output characteristics, and storage characteristics, and offers a good performance balance.

[Lithium Secondary Battery Positive Electrode]

The lithium secondary battery positive electrode of the present invention has a collector, and a positive electrode active material layer formed on the collector, wherein the positive electrode active material layer contains the complex oxide powder of the present invention for a lithium secondary battery positive electrode material, and a binding agent.

The positive electrode active material layer is made usually by mixing a positive electrode material, a binding agent, and as necessary a conductive material, a thickening agent, and others by a wet process, molding the mixture into a sheet, and attaching it to the positive electrode collector under pressure, or by dissolving or dispersing these materials in a liquid medium to make a slurry, applying the slurry on the positive electrode collector, and then drying it.

The material of the positive electrode collector is usually a metal material such as aluminum, stainless steel, nickel plating, titanium, or tantalum, or a carbon material such as carbon cloth or carbon paper. Among them, a metal material is preferable, and aluminum is particularly preferable. Examples of the shape of a metal material include a metal foil, a metal cylindrical column, a metal coil, a metal plate, a metal thin film, an expanded metal, a perforated metal, or a foamed metal, and examples of the shape of a carbon material include a carbon plate, a carbon thin film, and a carbon cylindrical column. Among them, a metal thin film is preferable because it is currently used for industrial products. The thin film may be as appropriate formed into a mesh.

In cases where a thin film is used as the positive electrode collector, the thickness thereof is preferably in the range of usually 1 μm or more, preferably 3 μm or more, and more preferably 5 μm or more, in addition, usually 100 mm or less, preferably 1 mm or less, and more preferably 50 μm or less. If the thickness is smaller than the above-described range, the collector may not have a sufficient strength, and if the thickness is greater than the range, handleability may be impaired.

The binding agent used for making the positive electrode active material layer is not particularly limited, and, when used under an application method, may be a material stable for a liquid medium used for making the electrode. Specific examples thereof include resin polymers such as polyethylene, polypropylene, polyethylene terephthalate, polymethyl methacrylate, aromatic polyamide, cellulose, and nitro cellulose, rubber polymers such as SBR (styrene-butadiene rubber), NBR (acrylonitrile-butadiene rubber), fluorine rubber, isoprene rubber, butadiene rubber, and ethylene-propylene rubber, thermoplastic elastomer polymers such as styrene-butadiene-styrene block copolymer and hydrogenated derivatives thereof, EPDM (ethylene-propylene-diene terpolymer), styrene-ethylene-butadiene-ethylene copolymer, and styrene-isoprene styrene block copolymer and hydrogenated derivatives thereof, soft resin polymers such as syndiotactic-1,2-polybutadiene, polyvinyl acetate, ethylene-vinyl acetate copolymer, and propylene-α-olefin copolymer, fluorine polymers such as polyvinylidene fluoride, polytetrafluoroethylene, fluorinated polyvinylidene fluoride, and polytetrafluoroethylene-ethylene copolymer, and polymer compositions having ion conductivity for alkali metal ions (particularly lithium ions). These substances may be used alone, or in combination of two or more of them in an optional combination and ratio.

The proportion of the binding agent in the positive electrode active material layer is usually 0.1% by weight or more, preferably 1% by weight or more, and further preferably 5% by weight or more, in addition, usually 80% by weight or less, preferably 60% by weight or less, further preferably 40% by weight or less, and most preferably 10% by weight or less. If the proportion of the binding agent is too low, the positive electrode lacks mechanical strength because it cannot sufficiently hold the positive electrode active material, which may result in the deterioration of the battery performance such as cycle characteristics, and if too high, the decrease of the battery capacity or electrical conductivity may occur.

The positive electrode active material layer usually contains a conductive material for increasing the electrical conductivity. The conductive material is not particularly limited as to its kind, and specific examples thereof include metal materials such as copper and nickel, and carbon materials including graphite such as natural graphite and artificial graphite, carbon black such as acetylene black, and amorphous carbon such as needle cokes. These substances may be used alone, or in combination of two or more of them in an optional combination and ratio. The proportion of the conductive material in the positive electrode active material layer is usually 0.01% by weight or more, preferably 0.1% by weight or more, and further preferably 1% by weight or more, in addition, usually 50% by weight or less, preferably 30% by weight or less, and further preferably 15% by weight or less. If the proportion of the conductive material is too low, the electrical conductivity may be insufficient, and if too high, the battery capacity may decrease.

The liquid medium for forming a slurry is not particularly limited as to its kind and may be either an aqueous solvent or an organic solvent as long as it can dissolve or disperse the lithium nickel manganese cobalt complex oxide powder as the positive electrode material, and a binding agent, in addition, a conductive material and a thickening agent which are optionally used. Examples of the aqueous solvent include water and alcohols, and examples of the organic solvent include N-methylpyrrolidone (NMP), dimethylformamide, dimethylacetamide, methyl ethyl ketone, cyclohexanone, methyl acetate, methyl acrylate, diethyltriamine, N—N-dimethylaminopropylamine, ethylene oxide, tetrahydrofuran (THF), toluene, acetone, dimethylether, dimethylacetamide, hexamethylenephosphoramide, dimethylsulfoxide, benzene, xylene, quinoline, pyridine, methylnaphthalene, and hexane. In particular when an aqueous solvent is used, a dispersant is added together with a thickening agent, and a slurry is made using a latex such as SBR. These solvents may be used alone, or in combination of two or more of them in an optional combination and ratio.

The content proportion of the lithium nickel manganese cobalt complex oxide powder of the present invention as the positive electrode material in the positive electrode active material layer is usually 10% by weight or more, preferably 30% by weight or more, and further preferably 50% by weight or more, in addition, usually 99.9% by weight or less, and preferably 99% by weight or less. If the proportion of the complex oxide powder in the positive electrode active material layer is too high, the positive electrode tends to have an insufficient strength, and if too low, the capacity may be insufficient.

The thickness of the positive electrode active material layer is usually about 10 to 200 μm.

The positive electrode active material layer is obtained by applying the slurry to the positive electrode collector and drying it, and is then preferably subjected to compaction with a roller press or the like for increasing the packing density of the positive electrode active material.

[Lithium Secondary Battery]

The lithium secondary battery of the present invention includes the above-described lithium secondary battery positive electrode of the present invention which is capable of intercalating/deintercalating lithium, a negative electrode which is capable of intercalating/deintercalating lithium, and a nonaqueous electrolyte including a lithium salt as the electrolyte salt. In addition, it may also include a separator for retaining the nonaqueous electrolyte between the positive electrode and the negative electrode. In order to effectively prevent shorts caused by the contact between the positive and negative electrodes, intervention of such a separator is desirable.

<Negative Electrode>

The negative electrode is usually, in the same manner as the positive electrode, composed of a negative electrode collector having formed thereon a negative electrode active material layer.

Examples of the material of the negative electrode collector include metal materials such as copper, nickel, stainless steel, or nickel plated steel, and carbon materials such as carbon cloth or carbon paper. Examples of the shape of a metal material include a metal foil, a metal cylindrical column, a metal coil, a metal plate, and a metal thin film, and examples of the shape of a carbon material include a carbon plate, a carbon thin film, and a carbon cylindrical column. Among them, a metal thin film is preferable because it is currently used for industrial products. The thin film may be appropriately formed into a mesh. In cases where a thin metal layer is used as the negative electrode collector, the favorable thickness thereof is in the same range as the range described for the positive electrode collector.

The negative electrode active material layer is composed of a negative electrode active material. The negative electrode active material is not specifically limited as to its kind as long as it is capable of chemically intercalating/deintercalating lithium, and is usually a carbon material capable of intercalating/deintercalating lithium from the viewpoint of high level of safety.

The carbon material is not particularly limited as to its kind, and examples thereof include graphite such as artificial graphite and natural graphite, and pyrolysates of organic matters under various pyrolysis conditions. Examples of the pyrolysates of organic matters include coal derived cokes, petroleum cokes, carbides of coal derived pitch, carbides of petroleum pitch, or carbides of oxides of such pitch, needle cokes, pitch cokes, carbides of phenolic resins and crystal cellulose or partially graphitized carbon materials thereof, furnace black, acetylene black, and pitch-based carbon fiber. Among them, graphite is preferable, and particularly favorable ones are artificial graphite, purified natural graphite, or graphite materials composed of such graphite and pitch, which are prepared by subjecting readily graphitizable pitch derived from various raw materials to high heat temperature treatment, and mainly used after being subjected to various surface treatments. These carbon materials may be used alone, or in combination of two or more of them.

In cases where a graphite material is used as the negative electrode active material, the d value (interlayer distance) of the lattice plane (002 plane) determined by X-ray diffraction according to the Gakushin method is usually 0.335 nm or more, in addition, usually 0.34 mm or less, and preferably 0.337 nm or less.

The ash content in the graphite material is usually 1% by weight or less, preferably 0.5% by weight or less, and particularly preferably 0.1% by weight or less with reference to the weight of the graphite material.

The crystallite size (Lc) of the graphite material determined by X-ray diffraction according to the Gakshin method is usually 30 mm or more, preferably 50 nm or more, and particularly preferably 100 nm or more.

The median diameter of the graphite material determined by a laser diffraction-scattering method is usually 1 μm or more, preferably 3 μm or more, further preferably 5 μm or more, particularly preferably 7 μm or more, in addition, usually 100 μm or less, preferably 50 μm or less, further preferably 40 μm or less, and particularly preferably 30 μm or less.

The BET specific surface area of the graphite material is usually 0.5 m²/g or more, preferably 0.7 m²/g or more, more preferably 1.0 m²/g or more, and further preferably 1.5 m²/g or more, in addition, usually 25.0 m²/g or less, preferably 20.0 m²/g or less, more preferably 15.0 m²/g or less, and further preferably 10.0 m²/g or less.

When the graphite material is subjected to Raman spectrum analysis using an argon laser beam, the intensity ratio I_{A}/I_{B} between the intensity I_{A} of the peak P_{A} detected in the range of 1580 to 1620 cm⁻¹ and the intensity I_{B} of the peak P_{B} detected in the range of 1350 to 1370 cm⁻¹ is preferably from 0 to 0.5. The half width of the peak P_{A} is preferably 26 cm⁻¹ or less, and more preferably 25 cm⁻¹ or less.

In addition to the above-described various carbon materials, other materials capable of intercalating/deintercalating lithium may be used as the negative electrode active material. Specific examples of the negative electrode active material other than carbon materials include metal oxides such as tin oxide and silicon oxide, sulfides, nitrides, elemental lithium, and lithium alloys such as a lithium aluminum alloy. These materials other than carbon materials also may be used alone, or in combination of two or more of them. In addition, they may be used in combination with the above-described carbon materials.

The negative electrode active material layer may be prepared usually by, in the same manner with the positive electrode active material layer, applying a slurry of the above-described negative electrode active material, a binding agent, and as necessary a conductive material and a thickening agent in a liquid medium to the negative electrode collector, and drying it. For the formation of the slurry, the above-described liquid medium, binding agent, thickening agent, conductive material, and others used for the positive electrode active material layer may be used in the same proportion.

<Nonaqueous Electrolyte>

The nonaqueous electrolyte may be, for example, a known organic electrolytic solution, a polymer solid electrolyte, a gelatinous electrolyte, or an inorganic solid electrolyte, and is particularly preferably an organic electrolytic solution. The organic electrolytic solution is composed of a solute (electrolyte) dissolved in an organic solvent.

The organic solvent is not particularly limited as to its kind, and examples thereof include carbonates, ethers, ketones, sulfolane compounds, lactones, nitrites, chlorinated hydrocarbons, ethers, amines, esters, amides, and phosphate compounds. Typical examples thereof include dimethyl carbonate, diethyl carbonate, ethyl methyl carbonate, propylene carbonate, ethylene carbonate, vinylene carbonate, tetrahydrofuran, 2-methyltetrahydrofuran, 1,4-dioxane, 4-methyl-2-pentanone, 1,2-dimethoxy ethane, 1,2-diethoxy ethane, 7-butyrolactone, 1,3-dioxolane, 4-methyl-1,3-dioxolane, diethyl ether, sulfolane, methyl sulfolane, acetonitrile, propionitrile, benzonitrile, butyronitrile, valeronitrile, 1,2-dichloroethane, dimethylformamide, dimethyl sulfoxide, trimethyl phosphate, and triethyl phosphate. They may be used as a single solvent or a mixed solvent composed of two or more of them.

The above-described organic solvent preferably contains a high permittivity solvent to dissociate the electrolyte salt. The high permittivity solvent means a compound having a relative permittivity of 20 or more at 25° C. Among the high permittivity solvents, ethylene carbonate, propylene carbonate, and substituted derivatives thereof in which hydrogen atoms have been substituted with other elements such as a halogen, alkyl groups, or the like are preferably contained in the electrolytic solution. The proportion of the high permittivity solvent to the electrolytic solution is preferably 20% by weight or more, further preferably 30% by weight or more, and most preferably 40% by weight or more. If the content of the high permittivity solvent is below the above-described range, desired battery characteristics may not be achieved.

The organic electrolytic solution may contain an additive such as CO₂, N₂O, CO, SO₂, or other gas, vinylene carbonate, or polysulfide Sₓ2⁻ at in optional proportion for forming a favorable film on the negative electrode surface to efficiently charge and discharge lithium ions. Among them, vinylene carbonate is preferable.

The electrolyte salt is also not particularly limited as to its kind, and may be a known optional solute. Specific examples thereof include LiClO₄, LiAsF₆, LiPF₆, LiBF₄, LiB(C₆H₅)₄, LiBOB, LiCl, LiBr, CH₃SO₃L₁, CF₃SO₃Li, LiN(SO₂CF₃)₂, LiN(SO₂C₂F₅), LiC(SO₂CF₃)₃, and LiN(SO₃CF₃)₂. These electrolyte salts may be optionally used alone, or in combination of two or more of them in an optional combination and ratio.

The content of the lithium salt as an electrolyte salt in the electrolytic solution is usually from 0.5 mol/L to 1.5 mol/L. If the concentration is below 0.5 mol/L or greater than 1.5 mol/L, the electric conductivity may decrease to adversely affect the battery characteristics. The lower limit of the concentration of the electrolyte salt is preferably 0.75 mol/L or more, and the upper limit thereof is preferably 1.25 mol/L or less.

In cases where a polymer solid electrolyte is used, its kind is not particularly limited, and a known optional crystalline or amorphous inorganic substance may be used as the solid electrolyte. Examples of the crystalline inorganic solid electrolyte include LiI, Li₃N, Li₁₊ₓJₓTi₂₋ₓ(PO₄)₃ (J=Al, Sc, Y, or La) and Li_{0.5-3x}RE_{0.5+x}TiO₃ (RE=La, Pr, Nd, or Sm). Examples of the amorphous inorganic solid electrolyte include oxide glass such as 4.9LiI-34.1Li₂O-61B₂O₅ and 33.3Li₂O-66.7SiO₂. These may be optionally used alone, or in combination of two or more in an optional combination and ratio.

<Separator>

In cases where the above-described organic electrolytic solution is used as the electrolyte, a separator is inserted between the positive and negative electrodes to prevent shorts between the electrodes. The separator is not particularly limited as to its material or shape, but is preferably stable to the organic electrolytic solution to be used, excellent in liquid retention properties, and securely prevent shorts between the electrodes. Preferable examples thereof include a microporous film, sheet, and nonwoven fabric composed of various polymer materials. Specific examples of the polymer material include polyolefin polymers such as nylon, cellulose acetate, nitrocellulose, polysulfone, polyacrylonitrile, polyvinylidene fluoride, polypropylene, polyethylene, and polybutene. In particular, polyolefin polymers are preferable from the viewpoint of chemical and electrochemical stability, which are important factors of the separator, and polyethylene is particularly preferable from the viewpoint of the self-closing temperature, which is one of the intended purpose of the separator in a battery.

In cases where a separator made of polyethylene is used, from the viewpoint of high temperature dimensional stability, ultrahigh molecular weight polyethylene is preferable, and the lower limit of the molecular weight is 500,000, further preferably 1,000,000, and most preferably 1,500,000. On the other hand, the upper limit of the molecular weight is preferably 5,000,000, further preferably 4,000,000, and most preferably 3,000,000. If the molecular weight is too high, the fluidity tends to be so low that pores of the separator may not sometimes be closed when heated.

<Battery Shape>

The lithium secondary battery of the present invention is prepared by assembling the above-described lithium secondary battery positive electrode of the present invention, a negative electrode, a nonaqueous electrolyte, and as necessary a separator into an appropriate shape. In addition, other constituents such as a covering case may be used as necessary.

The shape of the lithium secondary battery of the present invention is not particularly limited, and may be appropriately selected from various types of commonly used shapes according to the intended use. Examples of the shape include a cylinder type in which sheet electrodes and a separator are spirally disposed, a cylinder type having an inside out structure composed of pellet electrodes and a separator, and a coin type in which pellet electrodes and a separator are stacked.

The method for assembling the battery is also not particularly limited, and may be appropriately selected from various commonly used methods according to the shape of the intended battery.

<Charge Potential of Fully Charged Positive Electrode>

The lithium secondary battery of the present invention is preferably designed such that the charge potential of the fully charged positive electrode is 4.4 V (vs. Li/Li⁺) or more. The lithium secondary battery having a positive electrode including the complex oxide powder of the present invention has high cycle characteristics and is highly safe when charged to a high charge potential. The secondary battery may be used at a charge potential below 4.4 V.

The lithium secondary battery of the present invention has been described above, but the lithium secondary battery of the present invention is not limited to the above-described embodiments.

### EXAMPLES

The present invention is described below further in detail with reference to examples, but the present invention is not limited to these example without departing from the scope of the invention.

[Method of Physical Properties Measurement]

Physical properties and others of the complex oxide powder prepared in the following Examples and Comparative Examples were measured as described below.

Composition (Li/Ni/Mn/Co)

Determined by ICP-AES analysis.

Crystal Phase

Determined from a X-ray powder diffraction pattern using CuKα radiation.

(X-ray powder diffractometer) PANalytical PW1700

(Measurement conditions) X-ray output: 40 kV, 30 mA, scan axis=θ/2θ

Scan range (2θ): 10.0-90.0°

Measurement mode: Continuous

Scan width: 0.05°

Scan rate: 3.0°/min.

Slit: DS 1°, SS 1°, RS 0.2 mm

Lattice Constant

X-ray powder diffractometry was conducted using the above-described CuKα radiation, and, among the diffracting planes having the layered R(-3)m structure, the plane indices (hkl)=(003), (101), (006), (012), (104), (015), (107), (108), (110), and (113) were used for the calculation.

Specific Surface Area

BET one point measurement was conducted according to a continuous flow method with AMS 8000, a full automatic specific surface area analyzer manufactured by Ohkura Riken Inc., using nitrogen and helium as the adsorption gas and carrier gas, respectively. More specifically, the powder sample was heated and deaerated using a mixed gas at a temperature of 150° C., subsequently cooled to the temperature of liquid nitrogen to adsorb the mixed gas, thereafter warmed to room temperature using water to desorb the adsorbed nitrogen gas, and the amount of the gas was detected with a thermal conductivity detector, from which the specific surface area of the sample was calculated.

Average Primary Particle Diameter

Determined as an average particle diameter of about 10 to 30 primary particles in a 30,000 magnified SEM image.

Median Diameter and 90% Integrated Diameter (D₉₀) of Secondary Particles

The particle diameter was measured using a laser diffraction/scattering particle size distribution analyzer at a refractive index of 1.24 and on the basis of the particle volume diameter. The dispersion medium used for the measurement was 0.1% by weight sodium hexametaphosphate aqueous solution, and the measurement was conducted after ultrasonic dispersion for 5 minutes.

Bulk Density

10 to 11 g of the sample powder was placed in a 10-ml glass graduated cylinder, and the bulk density was determined as the powder packing density after 200 times of tapping with a stroke of about 20 mm.

Carbon Concentration C

EMIA-520 carbon/sulfur analyzer manufactured by Horiba, Ltd. was used. Dozens to 100 mg of the sample was weighed and placed in a baked magnetic crucible, to which a combustion improver was added, and C was burned and extracted in an oxygen gas flow in a high frequency heating furnace. The quantity of CO₂ in the combustion gas was determined by non-dispersive infrared absorption photometry. For the sensitivity calibration, 150-15 low alloy No. 1 manufactured by The Japan Iron and Steel Federation (C guaranteed value: 0.469% by weight) was used.

Volume Resistivity

A powder resistivity measuring apparatus (powder resistivity measuring system LORESTA GP, manufactured by DIA Instruments Co., Ltd.) was used to measure the volume resistivities [Ω·cm] of sample powders compacted at various pressures using a probe unit for powders (four-probe ring electrode; electrode spacing, 5.0 mm; electrode radius, 1.0 mm; sample radius, 12.5 mm) under the conditions of a sample weight of 3 g and an applied-voltage limiter of 90 V. The values of volume resistivity as measured under a pressure of 40 MPa were compared.

Median Diameter of Pulverized Particles in Slurry

The measurement was conducted using a known laser diffraction/scattering particle size distribution analyzer at a refractive index of 1.24 and on the basis of the particle volume diameter. The dispersion medium was 0.1% by weight sodium hexametaphosphate aqueous solution, and the measurement was conducted after ultrasonic dispersion for 5 minutes.

Median Diameter as Average Particle Diameter of Raw Material LiOH Powder

The measurement was conducted using a known laser diffraction/scattering particle size distribution analyzer at a refractive index of 1.14 and on the basis of the particle volume diameter. The dispersion medium was ethyl alcohol, and the measurement was conducted after ultrasonic dispersion for 5 minutes.

Physical Properties of Particulate Powder Obtained by Spray Drying

The morphology was confirmed by examination according to SEM observation and sectional SEM observation. The median diameter as the average particle diameter was measured using a known laser diffraction/scattering particle size distribution analyzer at a refractive index of 1.24 and on the basis of the particle volume diameter. The dispersion medium was 0.1% by weight sodium hexametaphosphate aqueous solution, and the measurement was conducted after ultrasonic dispersion for 5 minutes. The specific surface area was determined by the BET method.

[Production of Lithium Nickel Manganese Cobalt Complex Oxide Powder (Examples and Comparative Examples)]

### Example 1

Ni(OH)₂, Mn₃O₄, and Co(OH)₂ were weighed and mixed at a molar ratio of Ni:Mn:Co=0.347:0.440:0.167, to which pure water was added to prepare a slurry. With stirring the slurry, the solid content in the slurry was pulverized to a median diameter of 0.18 μm using a circulation type medium stirring mill.

To about 40 g of the particulate powder obtained by spray drying the slurry using a spray dryer (powder formed by aggregating the primary particles into solid secondary particles, average particle diameter: 10.1 μm, BET specific surface area: 73 m²/g), about 13 g of a LiOH powder pulverized to a median diameter of 20 μm or less was added. About 53 g of the powder before mixing was placed in a 500-ml wide mouthed plastic bottle, tightly closed, and mixed by shaking by hand for 20 minutes with a stroke of about 20 cm and about 160 blows per minute. The mixture before firing was charged into an alumina crucible, fired at 985° C. for 12 hours in an air flow (warming/cooling speed 5° C./min.), and then cracked to obtain a lithium nickel manganese cobalt complex oxide powder. The analysis of the Li/Ni/Mn/Co ratio revealed that x=0.055, y=0.159, and z=0.032. The difference with the above-described charge ratio is ascribable to the purity of the raw materials.

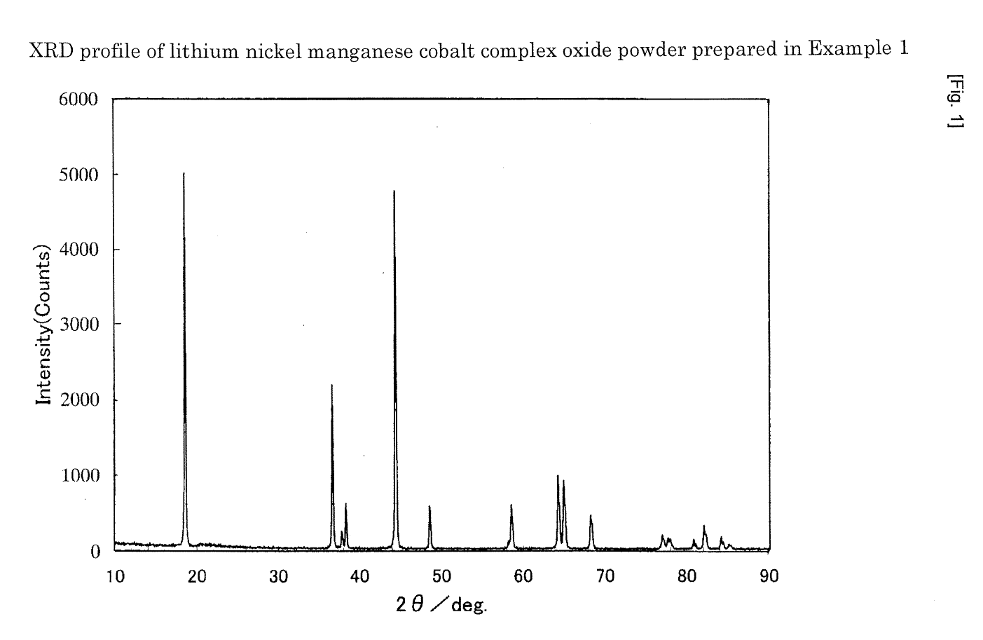

The XRD (X-ray powder diffraction) pattern of the complex oxide powder using CuKα radiation is shown in FIG. 1. As is evident from FIG. 1, no diffraction peak was observed at 2θ=31±1°. In addition, the crystal structure was confirmed to be composed of a layered R(-3)m structure. The average primary particle diameter of the powder was 0.6 μm, the median diameter of the secondary particles was 10.3 μm, the 90% integrated diameter (D₉₀) was 16.6 μm, the bulk density was 1.9 g/cc, the BET specific surface area was 1.16 m²/g, the carbon concentration C was 0.020% by weight, the volume resistivity under a pressure of 40 MPa was 1.0×10⁵ Ω·cm, the lattice constant along the a axis was 2.868 Å, and the lattice constant along the c axis was 14.260 Å.

### Example 2

To about 40 g of the same particulate powder as Example 1 obtained by spray drying the slurry using a spray dryer, about 13.6 g of a LiOH powder pulverized to a median diameter of 20 μm or less was added. About 53.6 g of the powder before mixing was placed in a 500-ml wide mouthed plastic bottle, tightly closed, and mixed by shaking by hand for 20 minutes with a stroke of about 20 cm and about 160 blows per minute. The mixture before firing was charged into an alumina crucible, fired at 985° C. for 12 hours in an air flow (warming/cooling speed 5° C./min.), and then cracked to obtain a lithium nickel manganese cobalt complex oxide powder. The analysis of the Li/Ni/Mn/Co ratio revealed that x=0.055, y=0.159, and z=0.076.

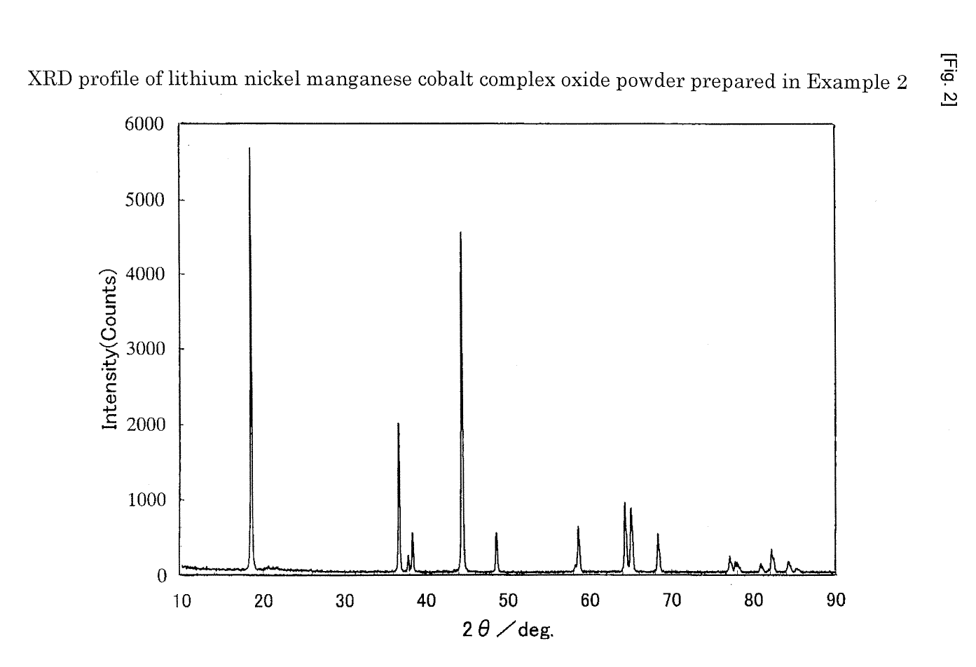

The XRD (X-ray powder diffraction) pattern of the complex oxide powder using CuKα radiation is shown in FIG. 2. As is evident from FIG. 2, no diffraction peak was observed at 2θ=31±1°. In addition, the crystal structure was confirmed to be composed of a layered R(-3)m structure. The average primary particle diameter of the powder was 0.6 μm, the median diameter of the secondary particles was 10.4 μm, the 90% integrated diameter (D₉₀) was 16.6 μm, the bulk density was 1.8 g/cc, the BET specific surface area was 1.00 m²/g, the carbon concentration C was 0.020% by weight, the volume resistivity under a pressure of 40 MPa was 2.6×10⁴ Ω·cm, the lattice constant along the a axis was 2.866 Å, and the lattice constant along the c axis was 14.254 Å.

### Example 3

Ni(OH)₂, Mn₃O₄, and Co(OH)₂ were weighed and mixed at a molar ratio of Ni:Mn:Co=0.278:0.463:0.167, to which pure water was added to prepare a slurry. With stirring the slurry, the solid content in the slurry was pulverized to a median diameter of 0.16 μm using a circulation type medium stirring mill.

To about 40 g of the particulate powder obtained by spray drying the slurry using a spray dryer (powder formed by aggregating the primary particles into solid secondary particles, average particle diameter: 10.6 μm, BET specific surface area: 66 m²/g), about 15.2 g of a LiOH powder pulverized to a median diameter of 20 μm or less was added. About 52.2 g of the powder before mixing was placed in a 500-ml wide mouthed plastic bottle, tightly closed, and mixed by shaking by hand for 20 minutes with a stroke of about 20 cm and about 160 blows per minute. The mixture before firing was charged into an alumina crucible, fired at 985° C. for 12 hours in an air flow (warming/cooling speed 5° C./min.), and then cracked to obtain a lithium nickel manganese cobalt complex oxide powder. The analysis of the Li/Ni/Mn/Co ratio revealed that x=0.133, y=0.159, and z=0.071.

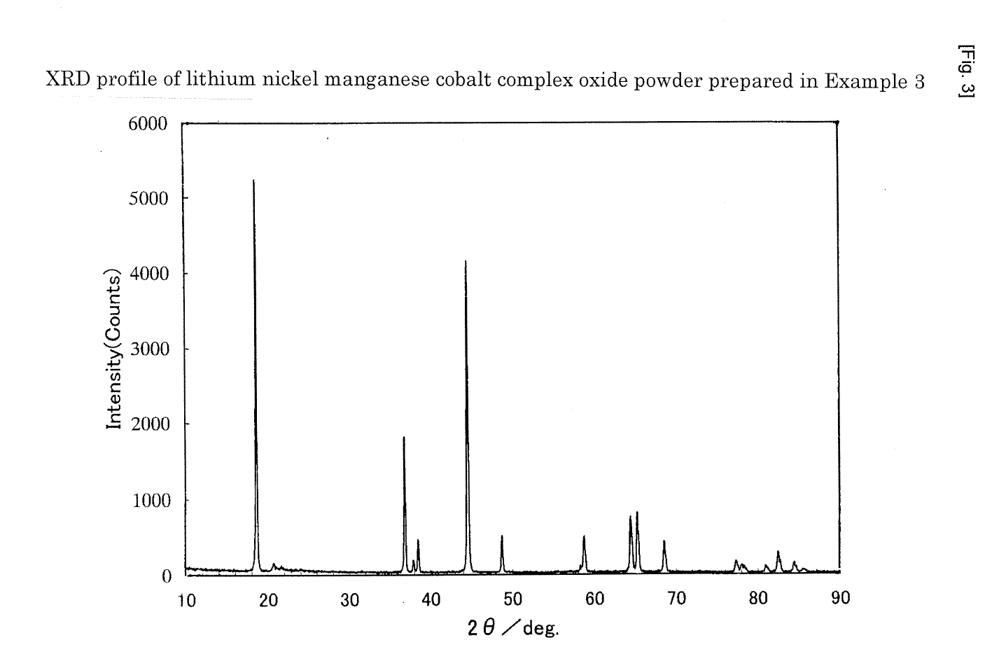

The XRD (X-ray powder diffraction) pattern of the complex oxide powder using CuKα radiation is shown in FIG. 3. As is evident from FIG. 3, no diffraction peak was observed at 2θ=31±1°. In addition, the crystal structure was confirmed to be composed of a layered R(-3)m structure. The average primary particle diameter of the powder was 0.7 μm, the median diameter of the secondary particles was 11.4 μm, the 90% integrated diameter (D₉₀) was 18.7 μm, the bulk density was 2.0 g/cc, the BET specific surface area was 0.94 m²/g, the carbon concentration C was 0.028% by weight, the volume resistivity under a pressure of 40 MPa was 3.6×10⁴ Ω·cm, the lattice constant along the a axis was 2.858 Å, and the lattice constant along the c axis was 14.239 Å.

### Example 4

To about 40 g of the same particulate powder as Example 3 obtained by spray drying the slurry using a spray dryer, about 14.6 g of a LiOH powder pulverized to a median diameter of 20 μm or less was added. About 54.6 g of the powder before mixing was placed in a 500-ml wide mouthed plastic bottle, tightly closed, and mixed by shaking by hand for 20 minutes with a stroke of about 20 cm and about 160 blows per minute. The mixture before firing was charged into an alumina crucible, fired at 985° C. for 12 hours in an air flow (warming/cooling speed 5° C./min.), and then cracked to obtain a lithium nickel manganese cobalt complex oxide powder. The analysis of the Li/Ni/Mn/Co ratio revealed that x=0.113, y=0.159, and z=0.033.

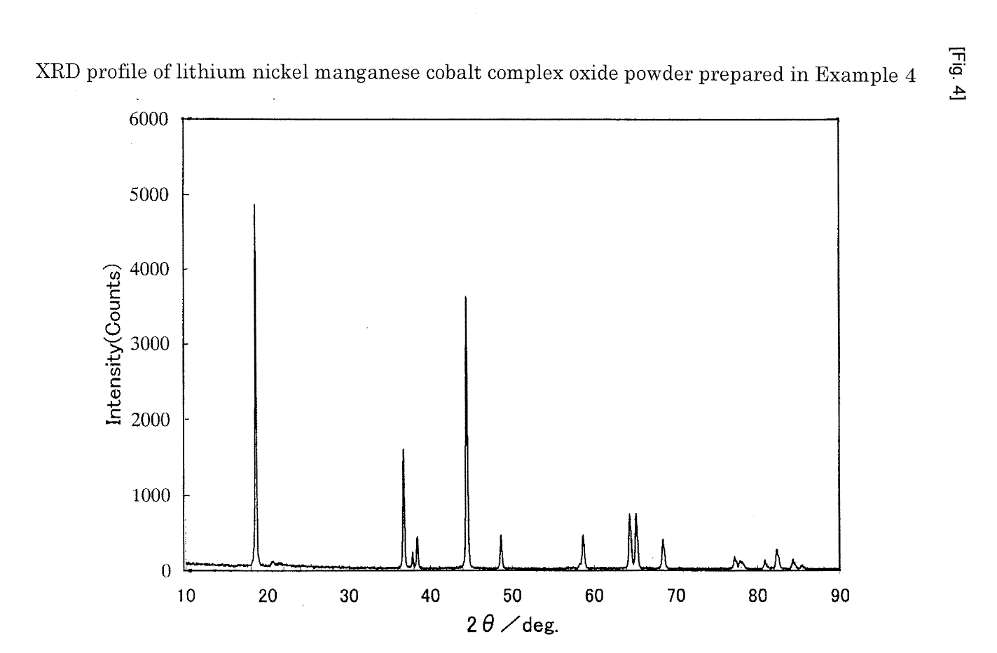

The XRD (X-ray powder diffraction) pattern of the complex oxide powder using CuKα radiation is shown in FIG. 4. As is evident from FIG. 4, no diffraction peak was observed at 2θ=31±1°. In addition, the crystal structure was confirmed to be composed of a layered R(-3)m structure. The average primary particle diameter was 0.6 μm, the median diameter of the secondary particles was 11.4 μm, the 90% integrated diameter (D₉₀) was 19.0 μm, the bulk density was 2.0 g/cc, the BET specific surface area was 1.13 m²/g, the carbon concentration C was 0.020% by weight, the volume resistivity under a pressure of 40 MPa was 2.0×10⁵ Ω·cm, the lattice constant along the a axis was 2.861 Å, and the lattice constant along the c axis was 14.250 Å.

### Comparative Example 1

To about 40 g of the same particulate powder as Example 1 obtained by spray drying the slurry using a spray dryer, about 12.5 g of a LiOH powder pulverized to a median diameter of 20 μm or less was added. About 52.5 g of the powder before mixing was placed in a 500-ml wide mouthed plastic bottle, tightly closed, and mixed by shaking by hand for 20 minutes with a stroke of about 20 cm and about 160 blows per minute. The mixture before firing was charged into an alumina crucible, fired at 985° C. for 12 hours in an air flow (warming/cooling speed 5° C./min.), and then cracked to obtain a lithium nickel manganese cobalt complex oxide powder. The analysis of the Li/Ni/Mn/Co ratio revealed that x=0.055, y=0.159, and z=−0.013.

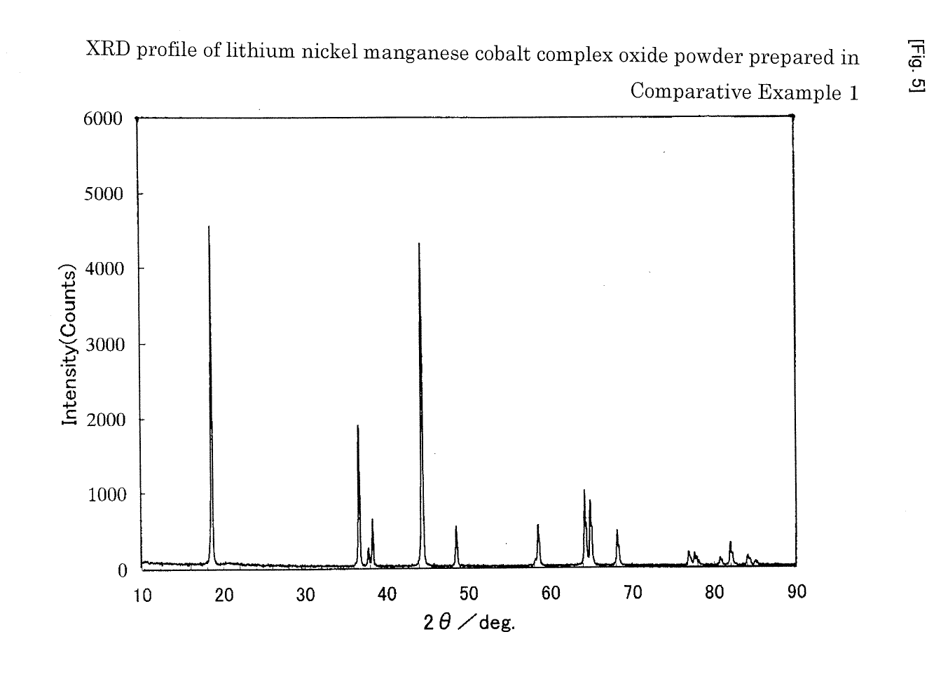

The XRD (X-ray powder diffraction) pattern of the complex oxide powder using CuKα radiation is shown in FIG. 5. As is evident from FIG. 5, no diffraction peak was observed at 2θ=31±1°. In addition, the crystal structure was confirmed to be composed of a layered R(-3)m structure. The average primary particle diameter was 0.6 μm, the median diameter of the secondary particles was 10.3 μm, the 90% integrated diameter (D₉₀) was 15.8 μm, the bulk density was 2.0 g/cc, the BET specific surface area was 1.17 m²/g, the carbon concentration C was 0.009% by weight, the volume resistivity under a pressure of 40 MPa was 1.3×10⁷ Ω·cm, the lattice constant along the a axis was 2.872 Å, and the lattice constant along the c axis was 14.269 Å.

### Comparative Example 2

To about 40 g of the same particulate powder as Example 3 obtained by spray drying the slurry using a spray dryer, about 15.8 g of a LiOH powder pulverized to a median diameter of 20 μm or less was added. About 55.8 g of the powder before mixing was placed in a 500-ml wide mouthed plastic bottle, tightly closed, and mixed by shaking by hand for 20 minutes with a stroke of about 20 cm and about 160 blows per minute. The mixture before firing was charged into an alumina crucible, fired at 985° C. for 12 hours in an air flow (warming/cooling speed 5° C./min.), and then cracked to obtain a lithium nickel manganese cobalt complex oxide powder. The analysis of the Li/Ni/Mn/Co ratio revealed that x=0.113, y=0.159, and z=0.106.

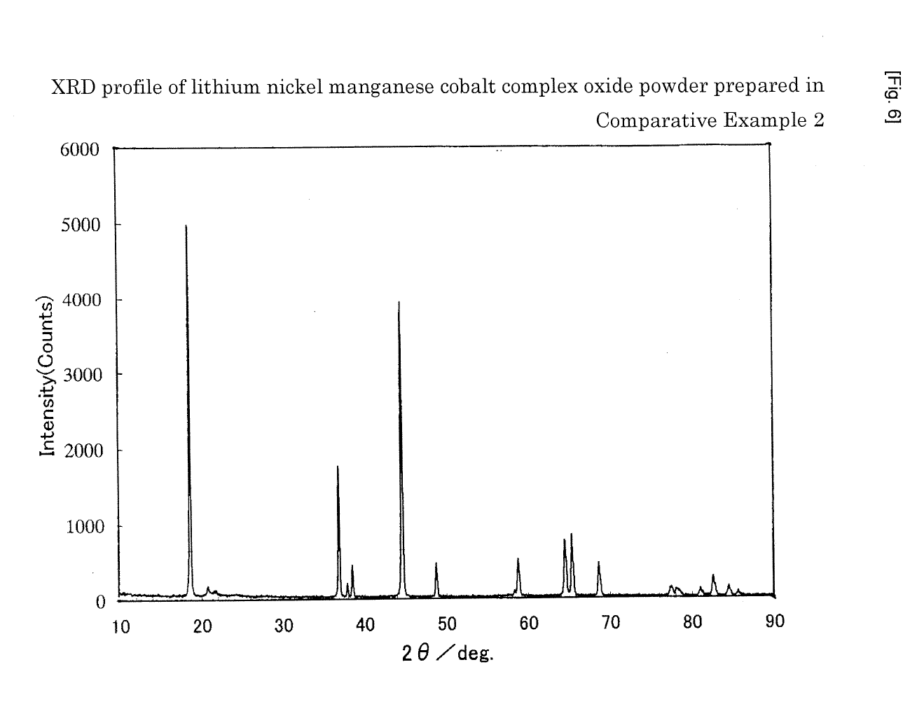

The XRD (X-ray powder diffraction) pattern of the complex oxide powder using CuKα radiation is shown in FIG. 6. As is evident from FIG. 6, no diffraction peak was observed at 2θ=31±1°. In addition, the crystal structure was confirmed to be composed of a layered R(-3)m structure. The average primary particle diameter of the powder was 0.7 μm, the median diameter of the secondary particles was 11.2 μm, the 90% integrated diameter (D₉₀) was 18.1 μm, the bulk density was 2.1 g/cc, the BET specific surface area was 0.36 m²/g, the carbon concentration C was 0.016% by weight, the volume resistivity under a pressure of 40 MPa was 2.0×10⁴ Ω·cm, the lattice constant along the a axis was 2.855 Å, and the lattice constant along the c axis was 14.234 Å.

### Comparative Example 3

LiOH.H₂O, NiO, Mn₃O₄, and CoOOH were weighed and mixed at a molar ratio of Li:Ni:Mn:Co=0.05:0.25:0.50:0.25, to which pure water was added to prepare a slurry. With stirring the slurry, the solid content in the slurry was pulverized to a median diameter of 0.19 μm using a circulation type medium stirring mill.

To about 40 g of the particulate powder obtained by spray drying the slurry using a spray dryer (powder formed by aggregating the primary particles into solid secondary particles, average particle diameter: 6.0 μm, BET specific surface area: 57.6 m²/g), about 14.4 g of a LiOH powder pulverized to a median diameter of 20 μm or less was added. About 54.4 g of the powder before mixing was placed in a 500-ml wide mouthed plastic bottle, tightly closed, and mixed by shaking by hand for 20 minutes with a stroke of about 20 cm and about 160 blows per minute. The mixture before firing was charged into an alumina crucible, fired at 900° C. for 12 hours in an air flow (warming/cooling speed 5° C./min.), and then cracked to obtain a lithium nickel manganese cobalt complex oxide powder. The analysis of the Li/Ni/Mn/Co ratio revealed that x=0.141, y=0.222, and z 0.005.

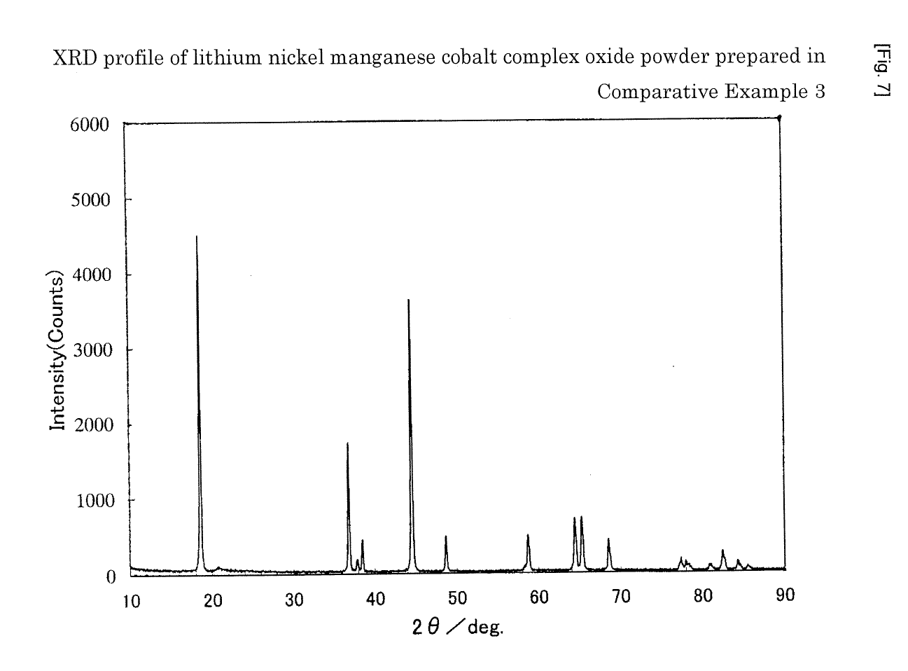

The XRD (X-ray powder diffraction) pattern of the complex oxide powder using CuKα radiation is shown in FIG. 7. As is evident from FIG. 7, no diffraction peak was observed at 2θ=31±1°. In addition, the crystal structure was confirmed to be composed of a layered R(-3)m structure. The average primary particle diameter was 0.3 μm, the median diameter of the secondary particles was 6.2 μm, the 90% integrated diameter (D₉₀) was 9.6 μm, the bulk density was 2.1 g/cc, the BET specific surface area was 0.98 m²/g, the carbon concentration C was 0.009% by weight, the volume resistivity under a pressure of 40 MPa was 3.4×10⁶ Ω·cm, the lattice constant along the a axis was 2.857 Å, and the lattice constant along the c axis was 14.248 Å.

### Comparative Example 4

To about 40 g of the same particulate powder as Example 3 obtained by spray drying the slurry using a spray dryer, about 13.3 g of a LiOH powder pulverized to a median diameter of 20 μm or less was added. About 53.3 g of the powder before mixing was placed in a 500-ml wide mouthed plastic bottle, tightly closed, and mixed by shaking by hand for 20 minutes with a stroke of about 20 cm and about 160 blows per minute. The mixture before firing was charged into an alumina crucible, fired at 900° C. for 12 hours in an air flow (warming/cooling speed 5° C./min.), and then cracked to obtain a lithium nickel manganese cobalt complex oxide powder. The analysis of the Li/Ni/Mn/Co ratio revealed that x=0.141, y=0.222, and z=−0.086.

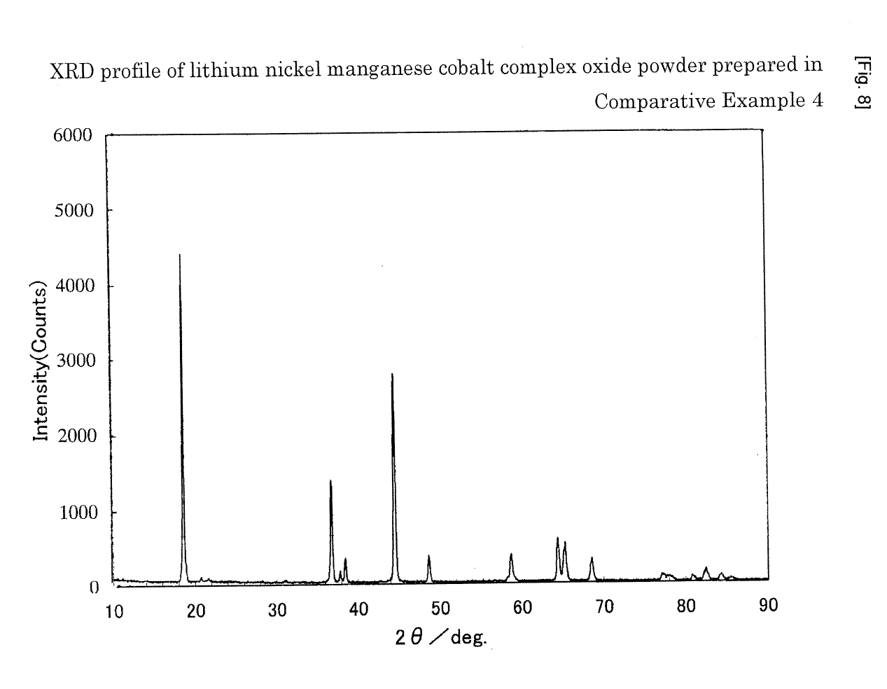

The XRD (X-ray powder diffraction) pattern of the complex oxide powder using CuKα radiation is shown in FIG. 8. As is evident from FIG. 8, a diffraction peak was observed at 2θ=31±1°. In addition, the crystal structure was confirmed to be composed of a layered R(-3)m structure. The average primary particle diameter was 0.5 μm, the median diameter of the secondary particles was 6.4 μm, the 90% integrated diameter (D₉₀) was 9.8 μm, the bulk density was 2.0 g/cc, the BET specific surface area was 0.70 m²/g, the carbon concentration C was 0.003% by weight, the lattice constant along the a axis was 2.857 Å, and the lattice constant along the c axis was 14.254 Å. The volume resistivity under a pressure of 40 MPa was unmeasurable because the resistance value exceeded the measurable range.

### Comparative Example 5

Ni(OH)₂, Mn₃O₄, and Co(OH)₂ were weighed and mixed at a molar ratio of Ni:Mn:Co=0.417:0.417:0.167, to which pure water was added to prepare a slurry. With stirring the slurry, the solid content in the slurry was pulverized to a median diameter of 0.17 μm using a circulation type medium stirring mill.

To about 40 g of the particulate powder obtained by spray drying the slurry using a spray dryer (powder formed by aggregating the primary particles into solid secondary particles, average particle diameter: 10.2 μm, BET specific surface area: 77 m²/g), about 12 g of a LiOH powder pulverized to a median diameter of 20 μm or less was added. About 52 g of the powder before mixing was placed in a 500-ml wide mouthed plastic bottle, tightly closed, and mixed by shaking by hand for 20 minutes with a stroke of about 20 cm and about 160 blows per minute. The mixture before firing was charged into an alumina crucible, fired at 985° C. for 12 hours in an air flow (warming/cooling speed 5° C./min.), and then cracked to obtain a lithium nickel manganese cobalt complex oxide powder. The analysis of the Li/Ni/Mn/Co ratio revealed that x=0, y=0.161, and z=0.056.

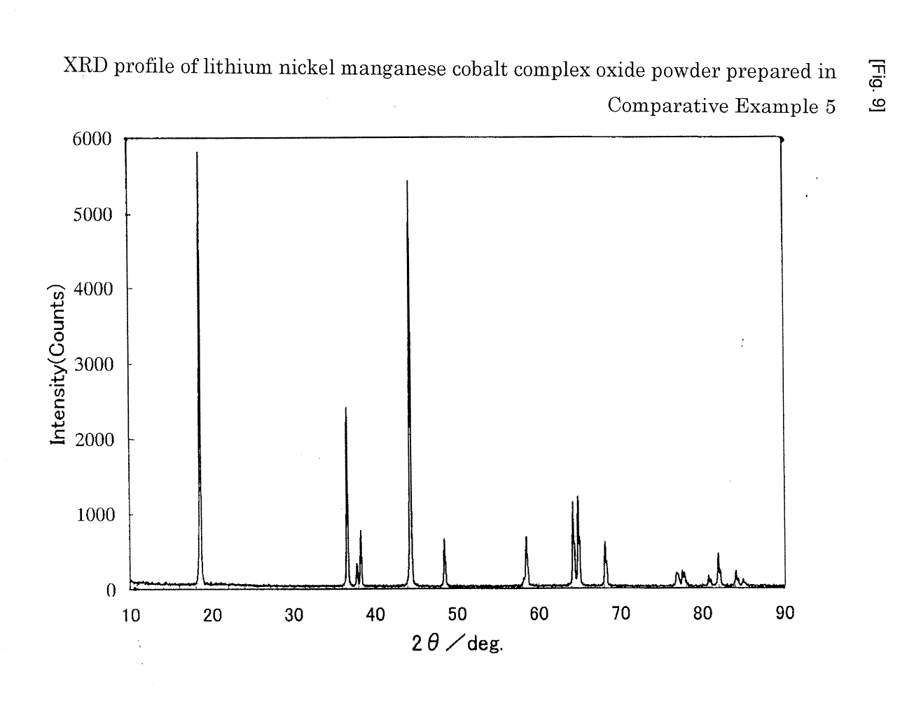

The XRD (X-ray powder diffraction) pattern of the complex oxide powder using CuKα radiation is shown in FIG. 9. As is evident from FIG. 9, no diffraction peak was observed at 2θ=31±1°. In addition, the crystal structure was confirmed to be composed of a layered R(-3)m structure. The average primary particle diameter of the powder was 0.7 μm, the median diameter of the secondary particles was 10.8 μm, the 90% integrated diameter (D₉₀) was 17.6 μm, the bulk density was 2.1 g/cc, the BET specific surface area was 1.03 m²/g, the carbon concentration C was 0.019% by weight, the volume resistivity under a pressure of 40 MPa was 3.0×10⁴ Ω·cm, the lattice constant along the a axis was 2.873 Å, and the lattice constant along the c axis was 14.265 Å.

The physical properties of the complex oxide powder obtained in the above-described Examples 1 to 4 and Comparative Examples 1 to 5 are summarized in Tables 1 and 2.

TABLE 1

| | | | | | | | | | | Presence or | Lattice | |
|---|---|---|---|---|---|---|---|---|---|---|---|---|
| | | Composition | | | | | Carbon | Volume | 2θ = 31 ± 1° | absence of | constant | |
| | | | | | z lower | z upper | concentration C | resistivity | Diffraction | layered R(−3)m | (Å) | |
| | | x | y | z | limit *1 | limit *2 | (% by weight) | (Ω · cm) | peak | structure | a | c |
| Example | 1 | 0.055 | 0.159 | 0.032 | 0.014 | 0.105 | 0.020 | 1.0 × 10⁵ | Absent | Present | 2.868 | 14.260 |
| | 2 | 0.055 | 0.159 | 0.076 | 0.014 | 0.105 | 0.020 | 2.6 × 10⁴ | Absent | Present | 2.866 | 14.254 |
| | 3 | 0.113 | 0.159 | 0.071 | 0.011 | 0.083 | 0.028 | 3.6 × 10⁴ | Absent | Present | 2.858 | 14.239 |
| | 4 | 0.113 | 0.159 | 0.033 | 0.011 | 0.083 | 0.020 | 2.0 × 10⁵ | Absent | Present | 2.861 | 14.250 |
| Comparative | 1 | 0.055 | 0.159 | −0.013 | 0.014 | 0.105 | 0.009 | 1.3 × 10⁷ | Absent | Present | 2.872 | 14.269 |
| Example | 2 | 0.113 | 0.159 | 0.106 | 0.011 | 0.083 | 0.016 | 2.0 × 10⁴ | Absent | Present | 2.855 | 14.234 |
| | 3 | 0.141 | 0.222 | 0.005 | 0.009 | 0.067 | 0.009 | 3.4 × 10⁶ | Absent | Present | 2.857 | 14.248 |
| | 4 | 0.141 | 0.222 | −0.086 | 0.009 | 0.067 | 0.003 | — | Present | Present | 2.857 | 14.254 |
| | 5 | 0.000 | 0.161 | 0.056 | 0.017 | 0.126 | 0.019 | 3.0 × 10⁴ | Absent | Present | 2.873 | 14.265 |

*1: 0.02(1 − y)(1 − 3x)
*2: 0.15(1 − y)(1 − 3x)

TABLE 2

| | | Average primary particle | Secondary particle | 90% integrated | | BET specific |
|---|---|---|---|---|---|---|
| | | diameter | median diameter | diameter (D₉₀) | Bulk density | surface area |
| | | (μm) | (μm) | (μm) | (g/cm³) | (m²/g) |
| Example | 1 | 0.6 | 10.3 | 16.6 | 1.9 | 1.16 |
| | 2 | 0.6 | 10.4 | 16.6 | 1.8 | 1.00 |
| | 3 | 0.7 | 11.4 | 18.7 | 2.0 | 0.94 |
| | 4 | 0.6 | 11.4 | 19.0 | 2.0 | 1.13 |
| Comparative | 1 | 0.6 | 10.3 | 15.8 | 2.0 | 1.17 |
| Example | 2 | 0.7 | 11.2 | 18.1 | 2.1 | 0.36 |
| | 3 | 0.3 | 6.2 | 9.6 | 2.1 | 0.98 |
| | 4 | 0.5 | 6.4 | 9.8 | 2.0 | 0.70 |
| | 5 | 0.7 | 10.8 | 17.6 | 2.1 | 1.03 |

[Assembly and Evaluation of Battery]

Lithium secondary batteries were assembled by the following method using each of the complex oxide powder prepared in the above-described Examples 1 to 4 and Comparative Examples 1 to 5 as the positive electrode material (positive electrode active material).

75% by weight of one of the complex oxide powder prepared in Examples 1 to 4 and Comparative Examples 1 to 5, 20% by weight of acetylene black, and 5% by weight of polytetrafluoroethylene powder were weighed and thoroughly mixed in a mortar, molded into a thin sheet, and perforated using a punch having a diameter of 9 mm. The overall weight was adjusted to about 8 mg. It was attached to an expanded aluminum metal under pressure to make a positive electrode having a diameter of 9 mm.

Coin type cells for rate test and high voltage cycle test were assembled using the positive electrode having a diameter of 9 mm as the test electrode, a lithium metal as the counter electrode, a 1 mol/L solution of LiPF₆ in a solvent composed of EC (ethylene carbonate), DMC (dimethyl carbonate), and EMC (ethyl methyl carbonate) at a ratio of 3:3:4 (volume ratio) as the electrolytic solution, and a porous polyethylene film having a thickness of 25 μm as the separator.

The thus assembled coin type cells were evaluated as follows.

1) Rate test: Each of the coin type cells was subjected to two cycles of charge and discharge at a constant current of 0.2 mA/cm², an upper charge voltage of 4.5 V, and a lower discharge voltage of 3.0 V, and then subjected to the third to tenth cycle of constant current charge at 0.5 mA/cm², followed by discharge at 0.2 mA/cm², 0.5 mA/cm², 1 mA/cm²/cm³, 3 MA/cm², 5 mA/cm², 7 mA/cm², 9 mA/cm², and 11 mA/cm². The low rate discharge capacity L (mAh/g) at 0.2 mA/cm² in the third cycle, the high rate discharge capacity H (mAh/g) at 11 mA/cm² in the tenth cycle, and the percentage (%) of the high rate discharge capacity H to the low rate discharge capacity L are listed in Table 3.

As the acceptance criteria, the above-described high rate discharge capacity in the tenth cycle was defined as 125 mAh/g or more, and the above-described percentage (%) of the high rate discharge capacity to the low rate discharge capacity was defined as 75% or more.

2) High Voltage Cycle Test:

Each of the coin type cells was subjected to two cycles of charge and discharge at a constant current of 0.2 mA/cm², an upper charge voltage of 4.6 V, and a lower discharge voltage of 3.0 V, and then subjected to the third to 52nd cycle of constant current charge and discharge at 0.5 mA/cm². The initial charge/discharge capacity (mAh/g) at 0.2 mA/cm² in the first cycle and the discharge capacity (mAh/g) at 0.5 mA/cm² in the third and 52nd cycle (3rd discharge capacity, 52nd discharge capacity), and the proportion (cycle retention rate=52nd discharge capacity/3rd discharge capacity×100) were determined, and the results are listed in Table 4. As the acceptance criteria, the above-described initial charge/discharge capacity in the first cycle (current density: 0.2 mA/cm²) thereof was defined as 185 mAh/g or more, the discharge capacity in the third cycle (current density: 0.5 mA/cm²) was defined as 175 mAh/g or more, and the cycle retention rate, which is the percentage of the discharge capacity in the 52nd cycle to that in the third cycle (current density: 0.5 mA/cm²), was defined as 86%.

TABLE 3

| | | Low rate | High rate | | |
|---|---|---|---|---|---|
| | | discharge | discharge | | |
| | | capacity L | capacity H | | |
| | | (mAh/g) | (mAh/g) | L/H × 100 (%) | Judgment |
| Example | 1 | 181.2 | 138.2 | 76 | ◯ |
| | 2 | 178.5 | 139.3 | 78 | ◯ |
| | 3 | 166.9 | 125.9 | 76 | ◯ |
| | 4 | 173.1 | 130.3 | 76 | ◯ |
| Comparative | 1 | 181.1 | 121.8 | 67 | X |
| Example | 2 | 159.0 | 114.1 | 72 | X |
| | 3 | 167.8 | 118.6 | 71 | X |
| | 4 | 158.2 | 108.7 | 69 | X |
| | 5 | 186.0 | 138.4 | 74 | X |

TABLE 4

| | | Initial charge/discharge | 3rd charge | 52nd charge | Cycle retention | | |
|---|---|---|---|---|---|---|---|
| | | capacity | capacity | capacity | rate | | Over-all |
| | | (mAh/g) | (mAh/g) | (mAh/g) | (%) | Judgment | judgment |
| Example | 1 | 229.5/197.4 | 184.8 | 159.4 | 86 | ◯ | ◯ |
| | 2 | 240.7/193.1 | 181.4 | 157.9 | 87 | ◯ | ◯ |
| | 3 | 264.8/188.7 | 176.7 | 167.7 | 95 | ◯ | ◯ |
| | 4 | 250.6/192.4 | 180.5 | 167.4 | 93 | ◯ | ◯ |
| Comparative | 1 | 224.4/196.0 | 182.7 | 156.3 | 86 | ◯ | X |
| Example | 2 | 285.0/183.7 | 171.7 | 168.9 | 98 | X | X |
| | 3 | 249.6/186.4 | 171.0 | 141.4 | 83 | X | X |
| | 4 | 234.5/172.7 | 157.2 | 131.8 | 84 | X | X |
| | 5 | 226.7/199.1 | 189.8 | 160.3 | 84 | X | X |

From Tables 3 and 4, the following facts are evident.

In Comparative Examples 1 and 3, the z value of the lithium nickel manganese cobalt complex oxide powder compositions is too small, so that the low electrical conductivity is low, and the high rate discharge capacity of the batteries is low.

In Comparative Example 2, the z value is too large, so that the discharge capacity of the battery is low at low and high rates.

In Comparative Example 4, the z value is even too small, the electrical conductivity is low, in addition, a diffraction peak derived from a spinel phase is detected, and the high rate discharge capacity and the cycle capacity retention rate of the battery are low.

In Comparative Example 5, the x value is too small, so that the durability is low at high voltages, and the cycle capacity retention rate is low.

On the other hand, it is evident that a lithium secondary battery which undergoes less cycle deterioration when used at high voltages, has a high capacity, excellent load characteristics, and offers a good performance balance is provided through the use of the lithium nickel manganese cobalt complex oxide powder of the present invention satisfying specific x, y, and z values as the positive electrode material.

The lithium secondary battery of the present invention is not particularly limited as to its applications, and may be used for various known applications. Specific examples thereof include a notebook PC, a tablet PC, a mobile PC, an electronic book player, a mobile phone, a mobile fax machine, a mobile copier, a mobile printer, a headphone stereo, a video movie, a liquid crystal display television, a handy cleaner, a portable CD, a MiniDisk, a transceiver, an electronic notepad, a pocket calculator, a memory card, a mobile tape recorder, a radio, a backup power source, motor, a lighting fixture, a toy, a game machine, a watch, a strobe, a camera, an electric tool, and an automotive power supply.

The present invention has been described in detail with reference to specific embodiments, but it will be evident to those skilled in the art that various modifications can be made without departing from the spirit and scope of the present invention.

The present application is based on Japanese Patent Application submitted on Feb. 8, 2005 (Japanese Patent Application No. 2005-031972), and the entirety thereof is incorporated by reference.

1. A complex oxide powder for a lithium secondary battery positive electrode material, the powder comprising a lithium nickel manganese cobalt complex oxide having a composition expressed by the following formula (I), and the complex oxide containing a crystal structure having a layered structure:
Li[Li_{z/(2+z)}{(LiₓNi_{(1-3x)/2}Mn_{(1+x)/2})_{(1-y})Co_{y}}_{2/(2+z)]O}₂ (I)
0≦y≦0.35
0.02(1−y)(1−3x)≦z≦0.15(1−y)(1−3x)

2. The complex oxide powder according to claim 1, wherein 0.05≦x≦0.12, 0.10≦y≦0.20, and 0.04(1−y)(1−3×)≦z≦0.13(1−y)(1−3x) in the formula (I).

3. The complex oxide powder according to claim 1, wherein there is no diffraction peak at 2θ=31±1° in a X-ray powder diffraction pattern using CuKα radiation.

4. The complex oxide powder according to claim 1, wherein the crystal structure is composed of a structure having a layered structure:
R 3̅m [formula 1]
, and the lattice constants thereof are in the range of 2.855 Å≦a≦2.870 Å, and 14.235 Å≦c≦14.265 Å.

5. The complex oxide powder according to claim 1, wherein there is a carbon concentration C (% by weight) of 0.030% by weight or less.

6. The complex oxide powder according to claim 1, wherein there is a volume resistivity of 5×10⁵ Ω·cm or less when consolidated under a pressure of 40 MPa.

7. The complex oxide powder according to claim 1, wherein there is a bulk density of 1.5 g/cc or more, an average primary particle diameter of 0.1 to 3 μm, and a secondary particle median diameter of 3 to 20 μm.

8. The complex oxide powder according to claim 1, wherein there is a BET specific surface area of 0.2 to 3.0 m²/g.

9. A method for preparing the complex oxide powder according to claim 1, comprising pulverizing a nickel compound, a manganese compound, and a cobalt compound, uniformly dispersing them to make a slurry, spray drying and/or pyrolyzing the slurry to agglomerate the primary particles into secondary particles to make powder, thereafter mixing the powder with a lithium compound, and firing the resultant mixture in an oxygen-containing gas atmosphere.

10. A lithium secondary battery positive electrode comprising a collector and a positive electrode active material layer formed on the collector, the positive electrode active material layer containing the complex oxide powder according to claim 1 and a binding agent.

11. A lithium secondary battery comprising a negative electrode capable of intercalating/deintercalating lithium, a nonaqueous electrolyte containing a lithium salt, and a positive electrode capable of intercalating/deintercalating lithium, the positive electrode being the lithium secondary battery positive electrode according to claim 10.

12. The lithium secondary battery according to claim 11, which is designed such that the charge potential of the fully charged positive electrode is 4.4 V (vs. Li/Li⁺) or more.
